(19) United States
(12) Patent Application Publication
(10) Pub. No.: US 2021/0193333 A1
(43) Pub. Date: Jun. 24, 2021

(54) CONTROL SYSTEM

(71) Applicant: Toshiba Lifestyle Products & Services Corporation, Kawasaki-shi (JP)

(72) Inventors: Takashi NISHIMURA, Seto-shi (JP); Hiroyuki MORITA, Owariasahi-shi (JP); Kazuki TOMII, Owariasahi-shi (JP); Akiyoshi TANAKA, Kasugai-shi (JP); Kyungpyo HONG, Owariasahi-shi (JP)

(73) Assignee: Toshiba Lifestyle Products & Services Corporation, Kawasaki-shi (JP)

(21) Appl. No.: 16/757,244

(22) PCT Filed: Sep. 13, 2018
(86) PCT No.: PCT/JP2018/034036

§ 371 Date: Apr. 17, 2020

(30) Foreign Application Priority Data
Oct. 26, 2017 (JP) 2017-207462
Oct. 26, 2017 (JP) 2017-207476

(51) Int. Cl. G16Y 40/30; D06F 34/08; G16Y 10/80; G16Y 20/20; D06F 34/32

(52) U.S. Cl. CPC G16Y 40/30; D06F 34/08; D06F 34/32; G16Y 20/20; G16Y 10/80

(57) ABSTRACT

A home appliance control system includes at least one home appliance, a server, a scheduler, and terminal devices. The server is configured to communicate with the at least one home appliance and may be configured to control an operation of the at least one home appliance. The scheduler may be stored in the server and configured to store each of schedule information of a plurality of users. The terminal devices are configured to access the scheduler. The terminal devices are configured to send the schedule information to the scheduler. The server is configured to control the operation of the at least one home appliance based on common schedule information among the schedule information of the users stored in the scheduler.

### TECHNICAL FIELD

The art disclosed herein relates to a home appliance control system and a controller.

### BACKGROUND ART

A technique for controlling an operation of a home appliance is known. In such a technique, for example, schedule information of a user is obtained, and the operation of the home appliance is controlled based on the obtained schedule information.

### SUMMARY OF INVENTION

### Technical Problem

In an environment in which a plurality of people lives together, such as a home or a dormitory, schedules of respective habitants are different. The description herein provides an art that can cause a home appliance to execute an operation that is highly convenient for users in an environment in which a plurality of users lives together.

### Solution to Technical Problem

A home appliance control system disclosed herein comprises at least one home appliance, a server, a scheduler, and terminal devices. The server is capable of communicating with the at least one home appliance and is configured to control an operation of the at least one home appliance. The scheduler is stored in the server and is configured to store each of schedule information of a plurality of users. The terminal devices are capable of accessing the scheduler. The terminal devices are capable of sending the schedule information to the scheduler. The server is capable of controlling the operation of the at least one home appliance based on common schedule information among the schedule information of the users stored in the scheduler.

In the above home appliance control system, the respective schedule information of the users received from the terminal devices is stored in the scheduler. Further, the server controls the operation of the at least one home appliance based on the common schedule information that is common among the schedule information. Since the server controls the operation of the home appliance by taking the respective schedule information of the users into account, the home appliance can be caused to execute the operation which is highly convenient for the users in an environment in which such a plurality of users lives together.

The present disclosure also discloses a controller controlling an electrical device. The controller comprises a receiver unit, a storage unit, and a control unit. The receiver unit is configured to receive schedule information of each of a plurality of users. The storage unit is configured to store the received respective schedule information of the users. The control unit is configured to control an operation of at least one electrical device. Each of the schedule information includes attribute information which indicates a status of corresponding one of the users. The control unit is capable of controlling the operation of the at least one electrical device based on the attribute information common to a predetermined number or more of the users among the schedule information of the users stored in the storage unit.

In the above controller, the electrical device can be caused to execute the operation which is highly convenient for as many users as possible even in the environment in which such a plurality of users lives together.

### BRIEF DESCRIPTION OF DRAWINGS

FIG. 1 is a block diagram showing a configuration of a home appliance control system 10.

FIG. 2 is a diagram showing an example of a table T1 displayed on display units of terminal devices of a first embodiment.

FIG. 3 is a diagram showing a flowchart of an operation schedule generation process which a server of the first embodiment executes.

FIG. 4 is a diagram showing an example of a table T2 displayed on the display units of the terminal devices of the first embodiment.

FIG. 5 is a diagram showing a flowchart of an operation start standby process which the server of the first embodiment executes.

FIG. 6 is a diagram showing an example of the table T1 displayed on the display units of the terminal devices of the first embodiment.

FIG. 7 is a diagram showing an example of the table T1 displayed on the display units of the terminal devices of the first embodiment.

FIG. 8 is a diagram showing a flowchart of an in-operation process which the server of the first embodiment executes.

FIG. 9 is a diagram showing an example of the table T1 displayed on the display units of the terminal devices of the first embodiment.

FIG. 10 is a diagram showing an example of the table T1 displayed on the display units of the terminal devices of the first embodiment.

FIG. 11 is a diagram showing an example of a table T3 displayed on the display units of the terminal devices of the first embodiment.

FIG. 12 is a diagram showing an example of a table T4 displayed on the display units of the terminal devices of the first embodiment.

FIG. 13 is a diagram showing an example of a table T5 displayed on the display units of the terminal devices of the first embodiment.

FIG. 14 is a diagram showing an example of a table T6 displayed on the display units of the terminal devices of the first embodiment.

FIG. 15 is a diagram showing an example of a table T7 displayed on the display units of the terminal devices of the first embodiment.

FIG. 16 is a diagram showing an example of a table T8 displayed on the display units of the terminal devices of the first embodiment.

FIG. 17 is a diagram showing an example of a table T9 displayed on the display units of the terminal devices of the first embodiment.

FIG. 18 is a diagram showing an example of a table T10 displayed on the display units of the terminal devices of the first embodiment.

FIG. 19 is a diagram showing an example of an image B10 displayed on the display units of the terminal devices of the first embodiment.

FIG. 20 is a diagram showing an example of a table T21 displayed on display units of terminal devices of a second embodiment.

FIG. 21 is a diagram showing a flowchart of an operation schedule generation process which a server of the second embodiment executes.

FIG. 22 is a diagram showing an example of a table T22 displayed on the display units of the terminal devices of the second embodiment.

FIG. 23 is a diagram showing a flowchart of an operation start standby process which the server of the second embodiment executes.

FIG. 24 is a diagram showing an example of the table T21 displayed on the display units of the terminal devices of the second embodiment.

FIG. 25 is a diagram showing an example of the table T21 displayed on the display units of the terminal devices of the second embodiment.

FIG. 26 is a diagram for explaining a predetermined condition which the server determines based on laundry loading information.

FIG. 27 is a diagram showing a flowchart of an in-operation process which the server of the second embodiment executes.

FIG. 28 is a diagram showing an example of the table T21 displayed on the display units of the terminal devices of the second embodiment.

FIG. 29 is a diagram showing an example of the table T21 displayed on the display units of the terminal devices of the second embodiment.

FIG. 30 is a diagram showing an example of the table T21 displayed on the display units of the terminal devices of the second embodiment.

FIG. 31 is a diagram showing an example of the table T21 displayed on the display units of the terminal devices of the second embodiment.

FIG. 32 is a diagram showing an example of the table T21 displayed on the display units of the terminal devices of the second embodiment.

FIG. 33 is a diagram showing an example of the table T21 displayed on the display units of the terminal devices of the second embodiment.

FIG. 34 is a diagram showing an example of a table T22 displayed on the display units of the terminal devices of the second embodiment.

FIG. 35 is a diagram showing an example of the table T22 displayed on the display units of the terminal devices of the second embodiment.

### DESCRIPTION OF EMBODIMENTS

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved home appliance control systems and controllers, as well as methods for using the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

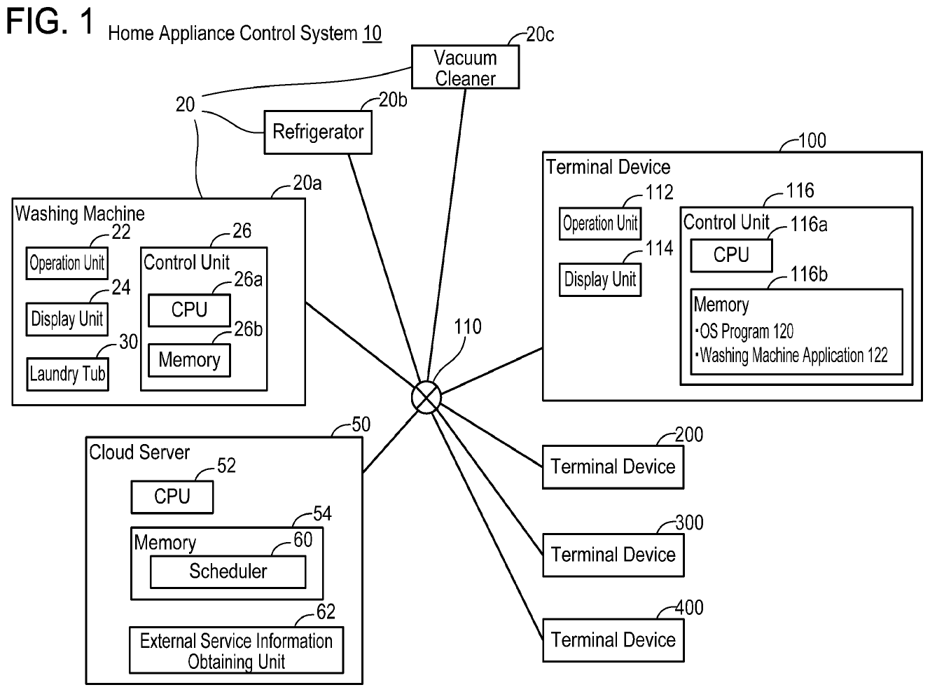

(Configuration of Home Appliance Control System 10) A home appliance control system 10 of a first embodiment will be described with reference to the drawings. As shown in FIG. 1, the home appliance control system 10 is provided with a plurality of home appliances 20, a cloud server 50 (hereinbelow simply termed a server 50), and terminal devices 100, 200, 300, 400. The plurality of home appliances 20, the server 50, and the terminal devices 100 to 400 are configured capable of communicating with each other through a communication network 110. The communication network 110 is not particularly limited, however, it may for example be the Internet, a wired LAN, a wireless LAN, or various combinations thereof.

The home appliance control system 10 is provided with a washing machine 20a, a refrigerator 20b, and a vacuum cleaner 20c, for example, as the plurality of home appliances 20. The vacuum cleaner 20c is a self-traveling robot cleaner. However, these home appliances 20 are mere examples, and the home appliance control system 10 may be provided with various types of home appliances 20 such as an air conditioner, an air purifier, a rice cooker, a microwave oven, an IH cooker, a TV, a recorder, and a heated water spray-equipped toilet seat. Further, the home appliance control system 10 may not necessarily be provided with a plurality of home appliances 20, and may be provided with at least one home appliance 20. Hereinbelow, a case of controlling an operation of the washing machine 20a will be described as an example of control of operations of the home appliances 20.

(Configuration of Washing Machine 20a)

The washing machine 20a is a so-called drum type washer and dryer, and is used by being shared in a home or a dormitory. The washing machine 20a is provided with an operation unit 22, a display unit 24, a control unit 26, and a laundry tub 30.

The operation unit 22 is provided with a plurality of buttons for executing respective functions of the washing machine 20a. When a user operates one of the buttons, the operation unit 22 sends a signal according to the operated button to the control unit 26. The display unit 24 includes a liquid crystal panel. The display unit 24 is controlled by the control unit 26 and is configured to display information necessary for performing laundry. The operation unit 22 may be configured integrally with the display unit 24 as a so-called touch panel.

The laundry tub 30 has a bottomed cylindrical shape with an opening at its front side. The laundry tub 30 is supported rotatable relative to a housing of the washing machine 20a by an outer tub (not shown). The laundry tub 30 is rotated by a motor (not shown) that obtained a signal from the control unit 26.

The control unit 26 is provided with a CPU 26a and a memory 26b. The control unit 26 is connected to the respective units 22, 24, 30 by wiring that is not shown so as to be capable of controlling them. The CPU 26a is a processor configured to control processes in the respective units 22, 24, 30 according to a program (not shown) stored in the memory 26b. The memory 26b is constituted of RAM and ROM.

The washing machine 20a is configured to accommodate laundry that is put into the laundry tub 30 and execute operations including a wash operation of executing a washing process, a rinsing process, and a spinning process, and a dry operation of executing a drying process of drying the laundry. The washing machine 20a is configured to execute an operation according to an operation mode that combines the aforementioned processes.

The terminal device 100 may for example be a portable terminal such as a cellphone, a smartphone, a PDA, a notebook PC, a tablet PC, a portable music player, and a portable motion reproducing device. The terminal device 100 is provided with an operation unit 112, a display unit 114, and a control unit 116.

The operation unit 112 is provided with a plurality of keys. The user may operate the operation unit 112 to input various instructions to the terminal device 100. The display unit 114 is a display configured to display various types of information (such as an operation schedule to be described later). The display unit 114 may function also as a so-called touch panel.

The control unit 116 is provided with a CPU 116a and a memory 116b. The control unit 116 is connected to the respective units 112, 114 by wiring that is not shown so as to be capable of controlling them. The CPU 116a is configured to execute various processes according to respective programs 120, 122 stored in the memory 116b. The OS program 120 is a program for controlling basic operations of the terminal device 100. The home appliance application 122 is an application provided by a vendor of the home appliances 20, and is installed to the terminal device 100 from a server on the communication network, for example. The home appliance application 122 is an application for causing communication of target data (such as schedule information and operation schedule to be described later) to be executed between the terminal device 100 and the server 50 and causing the target data to be displayed on the display unit 114 of the terminal device 100.

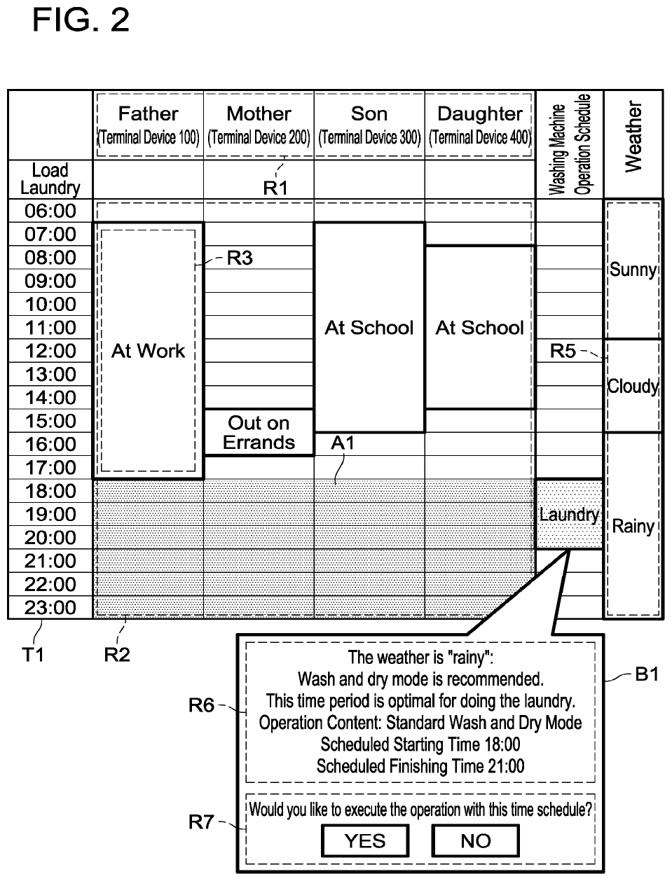

The respective terminal devices 200 to 400 have similar configurations as the terminal device 100. Hereinbelow, for the convenience of explanation, users of the respective terminal devices 100 to 400 will be explained as family members of one family. Specifically, as shown in a region R1 of FIG. 2, the explanation will be given by assuming that the user of the terminal device 100 is “father”, the user of the terminal device 200 is “mother”, the user of the terminal device 300 is “son”, and the user of the terminal device 400 is “daughter”.

The server 50 is a server provided on the communication network, and it may be a server provided by the vendor of the home appliances 20 or may be a server provided by a vendor different from that of the home appliances 20. The server 50 is configured capable of communicating with each of the plurality of home appliances 20 through the communication network 110 and is configured to control the operation of each home appliance 20. The server 50 is provided with a CPU 52 and a memory 54. The CPU 52 is configured to execute various processes in accordance with a program stored in the memory 54. The memory 54 stores a scheduler 60. The scheduler 60 is a program configured to manage schedule information of a plurality of users. In this embodiment, the scheduler 60 stores schedule information that is respectively received from the user of each of the terminal devices 100 to 400 by a communication interface of the server 50.

FIG. 2 shows an example of a table T1 in which the schedule information is stored. As shown in a region R2 of FIG. 2, the schedule information is information indicating a schedule of each of the users of the respective terminal devices 100 to 400. The schedule information each includes attribute information indicating a state of a corresponding user. In this embodiment, the attribute information is presence information indicating whether the user is home or not. That is, each of the schedules sent from the respective terminal devices 100 to 400 has an attribute “not home” indicating that this user is not home or an attribute “at home” indicating that this user is at home. For example, the schedule information “at work” indicated in a region R3 of FIG. 2 indicates that the father is in a state of being at work, and has the attribute “not home”. Similarly, “out on errands” and “at school” also have the attribute “not home”. Among the schedule information indicated in the region R2 of FIG. 2, time periods in which no schedule is registered have the attribute “at home”.

Further, the server 50 is provided with an external service information obtaining unit 62. The external service information obtaining unit 62 is configured to obtain external service information. In this embodiment, the external service information is weather information indicating weather of a predetermined period. The weather information indicates the weather such as “sunny”, “cloudy”, or “rainy” as indicated in a region R5 of FIG. 2, for example, and is stored in the scheduler 60.

The server 50 is configured to generate operation schedules for controlling the operations of the plurality of home appliances 20 based on the schedule information of the respective users and the external service information stored in the scheduler 60. Further, the server 50 sends the generated operation schedules to the terminal device 100. The operation schedules described herein include not only schedules for the home appliances 20 to execute their operations but also schedules for the home appliances 20 not executing their operations. Generation of the operation schedules will be described later in detail.

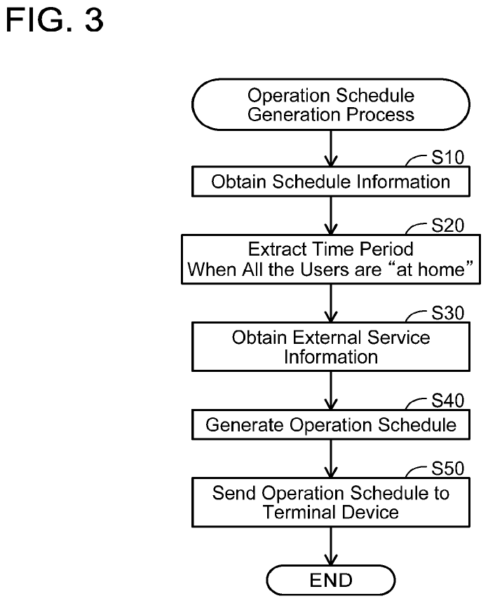

Next, respective processes which the server 50 executes will be described with reference to the drawings. Firstly, an operation schedule generation process for the server 50 to generate an operation schedule of the washing machine 20a will be described with reference to FIG. 3. The operation schedule generation process is initiated when the schedule information is respectively sent to the scheduler by the users of the respective terminal devices 100 to 400.

In S10, the server 50 obtains the schedule information of the respective users from the scheduler 60. Specifically, the schedule information of the father, mother, son, and daughter is obtained. The obtained schedule information is stored in the table T1 as shown in the region R3 of FIG. 2.

In S20, the server 50 extracts a time period during which all of the users have the attribute “at home”, that is, extracts common schedule information. More specifically, the server 50 respectively obtains time points when the attribute of the respective users changes from “not home” to “at home”, and extracts a time period starting from a latest time point from among the obtained time points as a time period when all of the users have the attribute “at home”. In this embodiment, as shown in FIG. 2, a time period starting from a time point when the father comes home (18:00) is extracted as the time period when all of the users commonly have the attribute “at home”. That is, as shown in FIG. 2, a common area A1 in which everyone has the attribute “at home” is extracted. This is because each user is expected to put his/her laundry of that day into the laundry tub 30 after the user comes home from outside, and the time period when all of the users have the attribute “at home” is to be determined as an optimal time period during which the operation of the washing machine 20a can be executed based on the common schedule information.

In S30, the server 50 obtains the external service information by using the external service information obtaining unit 62. In this embodiment, the external service information is the weather information. The weather information is the information indicating the weather of the predetermined period. The obtained weather information is stored in the table T1 as shown in the region R5 of FIG. 2.

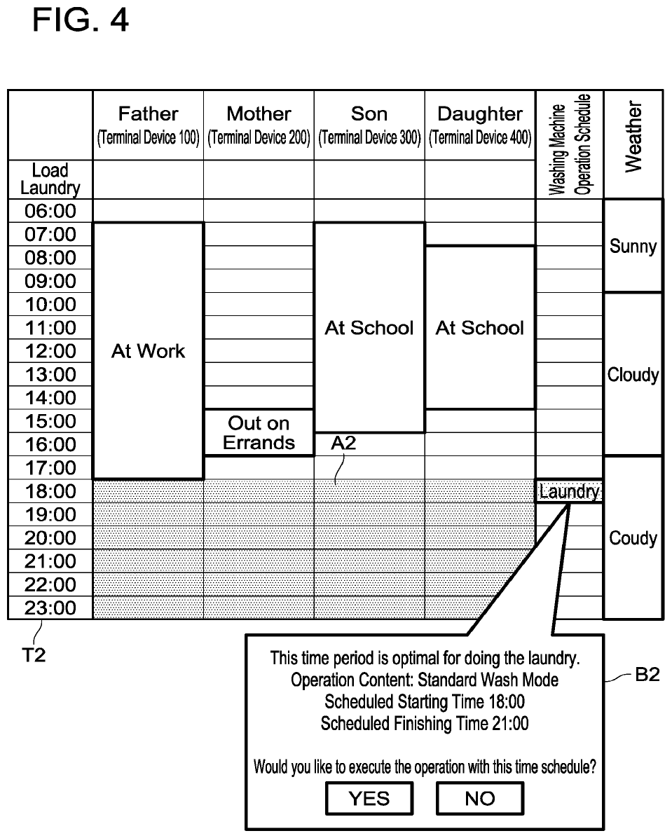

In S40, the server 50 generates the operation schedule of the washing machine 20a. Specifically, the server 50 determines the operation mode and an operating time of the washing machine 20a. In this embodiment, since the weather indicated by the weather information of the time period from 18:00, which is the time period extracted in S20, is “rainy”, the server 50 determines the operation mode to include the dry operation. Further, the server 50 calculates a duration of the operation required to execute the determined operation mode, and determines a time period in which the determined operation mode can be executed and completed. In this embodiment, 18:00 to 21:00 is determined from the common area A1 of FIG. 2, and the operation schedule that executes the operation in the operation mode including the dry operation is generated. For example, as in a table T2 shown in FIG. 4, in a case where the weather indicated by the weather information of the time period extracted in S20 (i.e., in a common area A2) is weather suitable for doing the laundry, such as “sunny”, the server 50 may determine the operation mode to not include the dry operation.

In S50, the server 50 sends the generated operation schedule to each of the terminal devices 100 to 400. When the operation schedule is received from the server 50, the terminal device 100 displays an image B1 for proposing the generated operation schedule to the user (a letter string image indicated in a region R6) as shown for example in FIG. 2. Further, in an example shown in FIG. 4, each of the terminal devices 100 to 400 displays an image B2 for proposing the generated operation schedule to its user. When the process of S50 is executed, the server 50 terminates the operation schedule generation process.

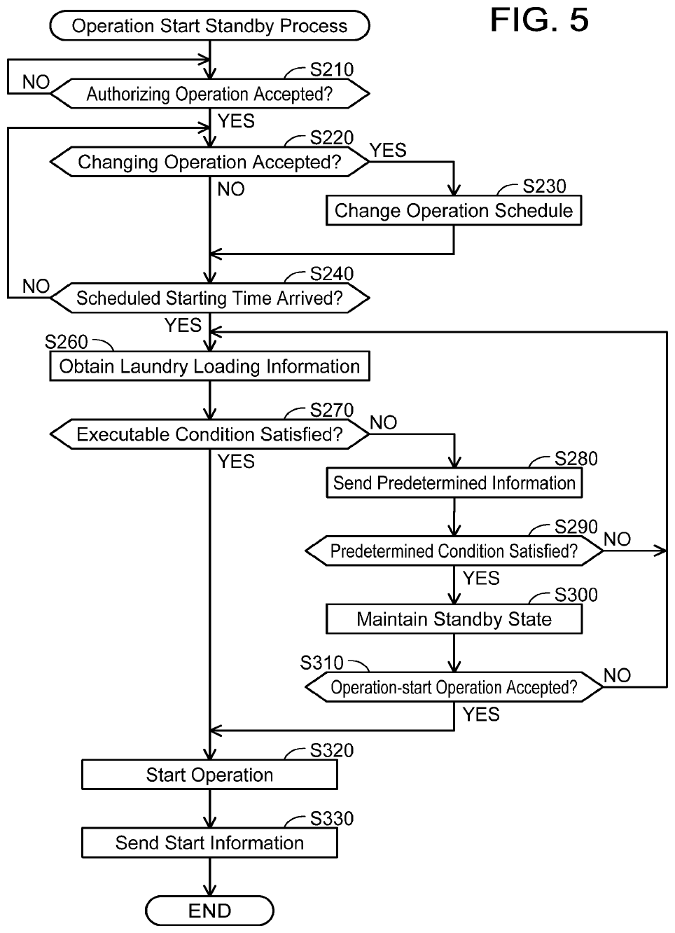

Next, an operation start standby process will be described with reference to FIG. 5. The operation start standby process is a process that is executed after the operation schedule generated by the server 50 has been sent to the respective terminal devices 100 to 400 and before the operation of the washing machine 20a is started. The operation start standby process is initiated when the process of S50 of FIG. 3 is executed. The operation schedule is received by each of the terminal devices 100 to 400, however, hereinbelow, the explanation will be given by focusing only on the terminal device 100 having received the operation schedule. The same applies to a second embodiment as well.

In S210, the server 50 determines whether or not an authorizing operation has been accepted. The authorizing operation is a user operation performed by the user (father) of the terminal device 100 which had received the operation schedule to select causing the washing machine 20a to execute the operation according to the operation schedule. Specifically, when the terminal device 100 receives the operation schedule, the image B1 (a letter string image indicated in a region R7) as shown in FIG. 2 for selecting whether or not to cause the washing machine 20a to execute the operation according to the operation schedule is displayed on the display unit 114. Then, in a case of determining that the user operation selecting “YES” has been accepted, the server 50 determines that the authorizing operation has been accepted. In the case of determining that the authorizing operation has been accepted, the server 50 causes the washing machine 20a to execute the operation according to the operation schedule. The server 50 proceeds to S220 in the case of an affirmative determination (YES to S210), and repeats S210 in a case of a negative determination (NO to S210).

In S220, the server 50 determines whether or not a changing operation has been accepted. The changing operation is a user operation for changing the operation schedule which the terminal device 100 had received. Specifically, in the case of having received the operation schedule, the terminal device 100 displays a screen for accepting a change to this operation schedule. An affirmative determination is made in a case where the user of the terminal device 100 inputs the user operation to change the operation schedule (such as a scheduled starting time and an operation content) to the operation unit 112 of the terminal device 100. The affirmative determination may be made in a case of determining that an input of the user operation to change the operation has been accepted in the operation unit 22 of the washing machine 20a. The server 50 proceeds to S230 in the case of the affirmative determination (YES to S220), and proceeds to S240 in a case of a negative determination (NO to S220).

In S230, the server 50 changes the operation schedule. The operation schedule is changed to the operation schedule to which the changing operation was accepted in S220.

In S240, the server 50 determines whether or not a scheduled starting time based on the operation schedule has arrived. In this embodiment, a determination is made on whether 18:00, which is the scheduled starting time, has arrived or not. The server 50 proceeds to S260 in a case of an affirmative determination (YES to S240), and returns to S220 in a case of a negative determination (NO to S240).

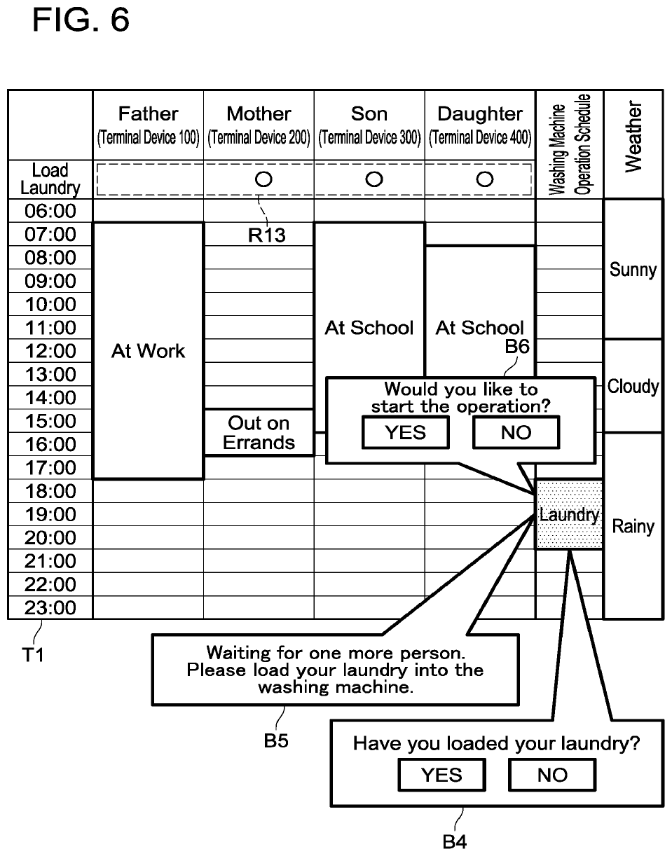

In S260, the server 50 obtains laundry loading information from the scheduler 60. The laundry loading information is information indicating whether or not the user has loaded his/her laundry into the laundry tub of the washing machine 20a. Specifically, the display unit 114 of the terminal device 100 displays an image B4 for selecting whether the user has loaded his laundry into the laundry tub 30, as shown in FIG. 6, for example. Then, in response to accepting a user operation selecting “YES” or “NO”, the laundry loading information indicating whether or not the laundry has been loaded into the laundry tub 30 of the washing machine 20a is stored in the table T1, as shown in a region R13 of FIG. 6. As above, the server 50 obtains the laundry loading information stored in the table T1 from the scheduler 60.

In S270, the server 50 determines whether or not an executable condition is satisfied. The executable condition is a condition indicating whether or not the washing machine 20a can be caused to execute the operation according to the operation schedule. In this embodiment, it is determined that the washing machine 20a can be caused to execute the operation according to the operation schedule in a case where common schedule information is present for all of the family members, that is, in a case where the laundry of all of the family members have been loaded. That is, in S270, the server 50 determines whether or not the laundry of all of the family members have commonly been loaded based on the laundry loading information. The server 50 proceeds to S320 in a case of an affirmative determination (YES to S270), and proceeds to S280 in a case of a negative determination (NO to S270).

In S280, the server 50 sends predetermined information to the terminal device 100. The predetermined information is information indicating a condition to satisfy the executable condition. In this embodiment, as aforementioned, the server 50 causes the washing machine 20a to execute the operation in the case of determining that the laundry of all of the family members have commonly been loaded. As such, as shown in the region R13 of FIG. 6, in a case where a number of users having loaded the laundry is three, the server 50 sends, to the terminal device 100, information indicating that the operation can be executed on condition that the laundry of one more person (father in the example of FIG. 6) is loaded. When the predetermined information is received from the server 50, the terminal device 100 displays an image B5, for example, for notifying the user of the condition indicated by the predetermined information.

In S290, the server 50 determines whether or not a predetermined condition is satisfied. The predetermined condition is a condition regarding a number of the users based on the schedule information of the users, and is preset as a minimum condition to evaluate as being “common”. In this embodiment, the predetermined condition is determined as being satisfied, based on the laundry loading information, when the laundry of two or more out of the four family members have been loaded. The server 50 proceeds to S300 in a case of an affirmative determination (YES to S290), and returns to S260 in a case of a negative determination (NO to S290).

In S300, the server 50 controls a state of the washing machine 20a to be in a standby state. The standby state is a state in which main power is on but a main function is not being used. In the example shown in FIG. 6, since the laundry of three users have been loaded, the server 50 controls the state of the washing machine 20a to be in the standby state to prepare for starting the operation of the washing machine 20a.

In S310, the server 50 determines whether or not an operation-start operation has been accepted. The operation-start operation is a user operation for the user to instruct the washing machine 20a to start the operation. Specifically, when the predetermined information is received from the server 50 in S280, the terminal device 100 displays an image B6 for selecting whether to cause the washing machine 20a to start the operation as shown in FIG. 6. Then, in a case of determining that the user operation selecting “YES” has been accepted, the server 50 determines that the operation-start operation has been accepted. The server 50 proceeds to S320 in a case of an affirmative determination (YES to S310), and returns to S260 in a case of a negative determination (NO to S310).

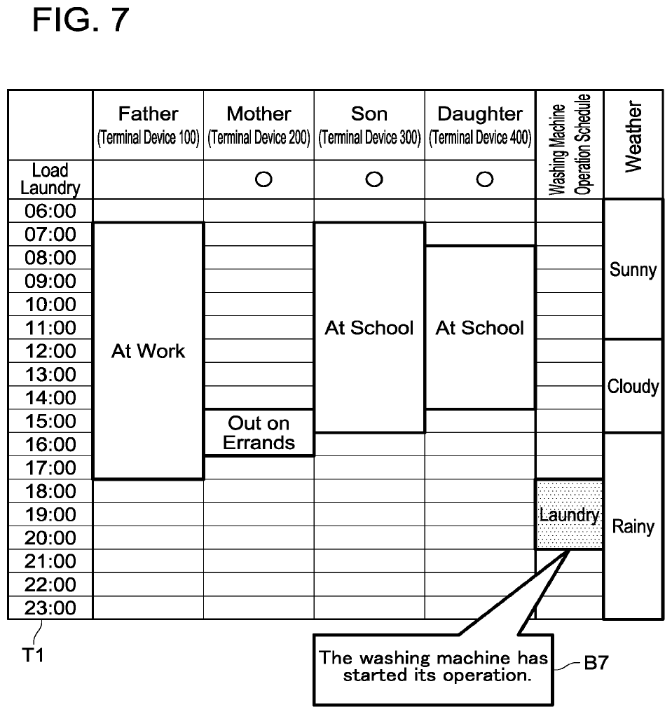

In S320, the server 50 causes the washing machine 20a to execute the operation according to the operation schedule. Then, in S330, the server 50 sends start information to the terminal device 100. The start information is information indicating that the operation of the washing machine 20a has started. When the start information is received from the server 50, the terminal device 100 displays an image B7 for notifying the user that the operation according to the operation schedule has started, as shown in FIG. 7 for example. When the process of S320 is executed, the server 50 terminates the operation start standby process.

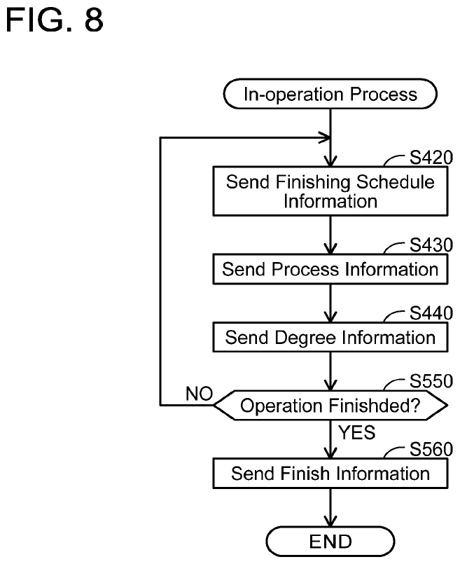

Next, an in-operation process will be described with reference to FIG. 8. The in-operation process is a process executed after the operation according to the operation schedule has been started. The in-operation process is executed after the process of S330 of FIG. 5 (i.e., sending of the start information) has been executed.

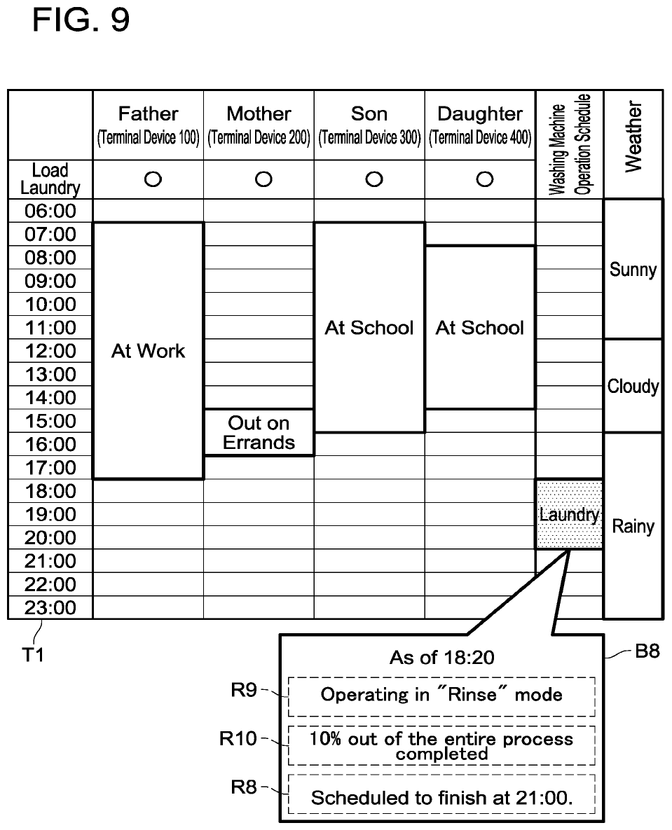

In S420, the server 50 sends finishing schedule information to the terminal device 100. The finishing schedule information is information indicating a scheduled finishing time of the operation of the washing machine 20a according to the operation schedule. When the finishing schedule information is received from the server 50, the terminal device 100 displays an image B8 (a letter string image indicated in a region R8) for notifying the user of the scheduled time when the operation is to finish, as shown in FIG. 9, for example.

In S430, the server 50 sends process information to the terminal device 100. The process information is information indicating an operation content which the washing machine 20a is currently executing. For example, when the process information indicating that the washing machine 20a is executing a “rinsing process” is received from the server 50, the terminal device 100 displays the image B8 (a letter string image indicated in a region R9) for notifying the user that the rinsing process is being executed, as shown in FIG. 9.

In S440, the server 50 sends degree information to the terminal device 100. The degree information is information indicating a degree of progress that has so far been made over the entire operation which the washing machine 20a is to execute (i.e., the entire operation according to the operation schedule). When the degree information is received from the server 50, the terminal device 100 displays the image B8 (a letter string image indicated in a region R10) for notifying the user of the degree of progress over all of processes in the operation schedule, as shown for example in FIG. 9.

In S550, the server 50 determines whether or not all of the operation according to the operation schedule has been finished. The server 50 proceeds to S560 in a case of an affirmative determination (YES to S550), and returns to S420 in a case of a negative determination (NO to S550). The processes of S420 to S440 may be executed once every predetermined time while the washing machine 20a is executing the operation, or may be executed at arbitrary timings. Further, the letter string images shown respectively in the regions R8, R9, R10 may be displayed as separate images.

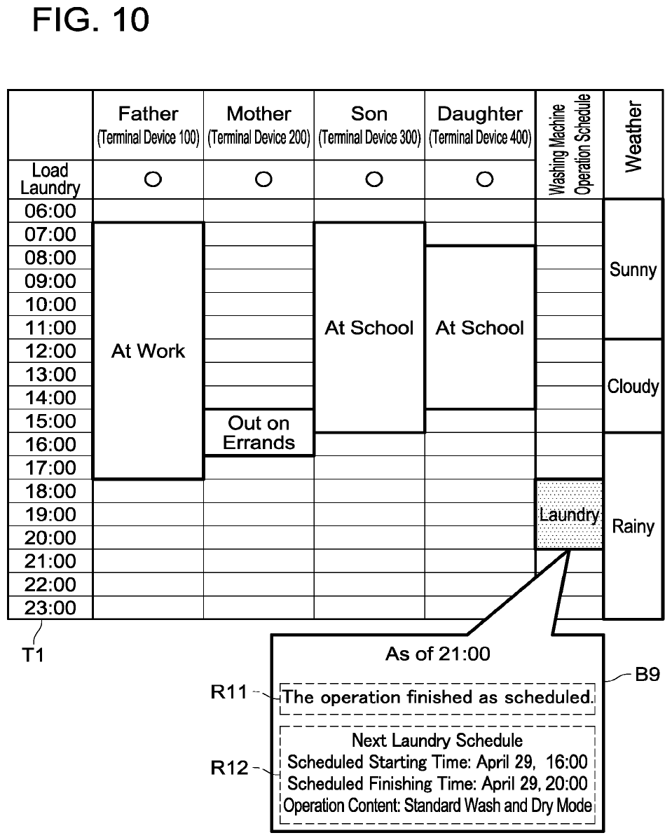

In S560, the server 50 sends finish information to the terminal device 100. The finish information is information indicating that the entire operation of the washing machine 20a has finished. When the finish information is received from the server 50, the terminal device 100 displays an image B9 (a letter string image indicated in a region R11) for notifying the user that the entire operation according to the operation schedule has finished, as shown for example in FIG. 10. When the process of S560 is executed, the server 50 terminates the in-operation process. After having executed the process of S560, the server 50 may re-execute the operation schedule generation process shown in FIG. 3 for controlling the operation of the washing machine 20a for next time, and send the generated operation schedule to the terminal device 100. In this case, as shown for example in FIG. 10, the terminal device 100 may display the image B9 (a letter string mage indicated in a region R12) for notifying the user of the received next operation schedule. By doing so, the user can acknowledge the operation of the washing machine 20a scheduled for the next time.

(Effects)

In the aforementioned home appliance control system 10, the schedule information of each of the users received from each of the terminal devices 100 to 400 is stored in the scheduler 60. Then, the server 50 controls the operation of the washing machine 20a based on the schedule information that is common to a plurality of the users (S320 of FIG. 5). As such, the server 50 determines and controls the operation of the washing machine 20a by taking into account the respective schedule information of the plurality of users, the washing machine 20a can be caused to execute operations with high convenience commonly for as many users as possible in the environment in which the plurality of users lives together.

Further, in the aforementioned home appliance control system 10, the operation schedule is generated so that the operation of the washing machine 20a is executed in the time period during which all of the users are determined as having the attribute “at home” (S40 of FIG. 3). Due to this, by executing the operation according to the generated operation schedule, the operation of the washing machine 20a can be started in the state where the laundry are loaded, and the convenience is improved.

Further, in the case of receiving the operation schedule from the server 50 (S50 of FIG. 3), each of the terminal devices 100 to 400 displays the image B1 for accepting the user operation to select whether to cause the washing machine 20a to execute the operation according to the operation schedule. Then, in the case of determining that the input of the authorizing operation was made by the user(s) (YES to S210 of FIG. 5), the server 50 causes the washing machine 20a to execute the operation according to the operation schedule (S320). As above, the users can instruct the washing machine 20a to execute the operation according to the proposed operation schedule through the communication network 110.

Further, in the case of receiving the operation schedule from the server 50 (S50 of FIG. 3), each of the terminal devices 100 to 400 displays the screen for accepting the user operation to change the operation according to the operation schedule. Then, in the case of determining that the input of the user operation to change the operation schedule is inputted by the user(s) (YES to S220 of FIG. 5), the server 50 generates the changed operation schedule (S230). Further, the server 50 causes the washing machine 20a to execute the operation according to the changed operation schedule (S320). As above, the users having received the operation schedule can remotely change the proposed operation schedule.

Further, the server 50 obtains the external service information (S30 of FIG. 3) and generates the operation schedule based on the schedule information and the external service information (S40). Further, the server 50 causes the washing machine 20a to execute the operation according to the operation schedule. As above, by reflecting the information externally obtained in addition to the schedule information of the users, the washing machine 20a can be caused to execute a more optimal operation.

Further, the server 50 sends the start information, the finishing schedule information, the process information, the degree information, and the finish information to each of the terminal devices 100 to 400 (S330 of FIG. 5, S420, S430, S440, and S560 of FIG. 8). Due to this, the users of the respective terminal devices 100 to 400 can accurately acknowledge a situation of the operation of the washing machine 20a according to the operation schedule.

Further, the server 50 obtains the laundry loading information from the scheduler 60 (S260 of FIG. 5). Then, it causes the washing machine 20a to execute the operation (S320) in response to satisfying the executable condition (YES to S270). As above, by withholding the operation until a predetermined amount of the laundry has been loaded even when the scheduled starting time has already arrived, laundry operation can efficiently be executed.

Further, in the case of not satisfying the executable condition (NO to S270), the server 50 sends the predetermined information indicating the condition for satisfying the executable condition to the respective terminal devices 100 to 400 (S280). Due to this, each user who has not loaded his/her laundry can be prompted to load his/her laundry, and the operation of the washing machine 20a can efficiently be executed.

Further, in the case of satisfying the predetermined condition (YES to S290), the server 50 controls the state of the washing machine 20a to be in the standby state (S300) even in the case of not satisfying the executable condition (NO to S270). Due to this, when the executable condition is satisfied thereafter, the washing machine 20a can be caused promptly to execute the operation.

Further, the server 50 causes the washing machine 20a to start the operation according to the operation schedule (S320) even in the case of not satisfying the executable condition (NO to S270) so long as it is determined that the operation-start operation has been accepted (YES to S310). As such, even in the case where the executable condition is not satisfied, the users can instruct the washing machine 20a to execute the operation with priority.

(Corresponding Relationship)

The authorizing operation is an example of a “first user operation”. The image B1 is an example of a “screen for accepting a first user operation”. The changing operation is an example of a “second user operation”. The operation-start operation is an example of a “third user operation”. The image B6 is an example of a “screen for accepting a third user operation”. The cloud server 50 is an example of a “controller”. The communication interface of the server 50 is an example of a “receiver unit”. The memory 54 is an example of a “storage unit”.

(Variant)

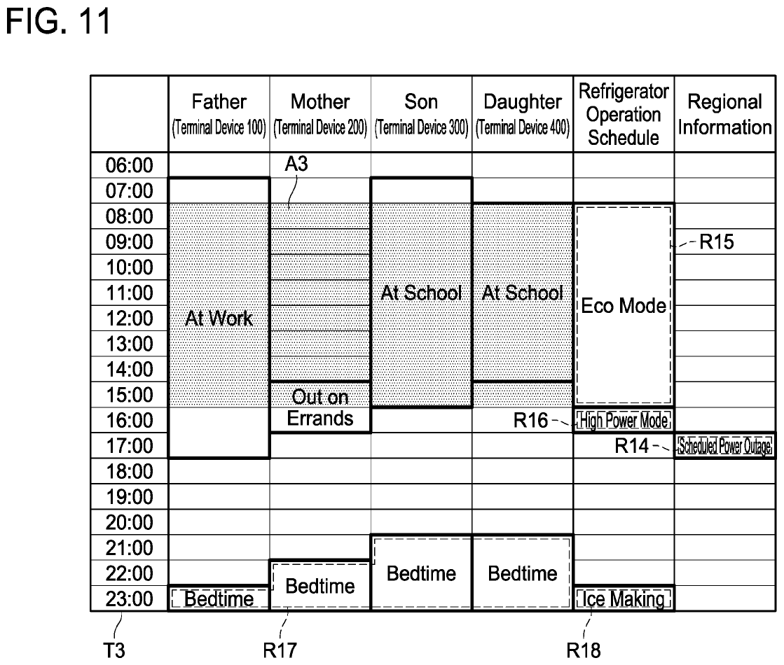

In the aforementioned home appliance control system 10, the server 50 may control an operation of the refrigerator 20b. In this case, in S20 of FIG. 3, the server 50 may extract a time period in which a predetermined number or more of the users has the attribute “not home” as the common schedule information. That is, S20 may be read as “extract a time period during which a predetermined number or more of the users are “not home””. The predetermined number may for example be three. Specifically, as shown for example in FIG. 11, 8:00 to 16:00, which is a time period during which three or more users have the attribute “not home”, is extracted as the common schedule (i.e., a common area A3).

In S30, the server 50 may obtain power outage information indicating a scheduled power outage as the external service information by using the external service information obtaining unit 62. The obtained power outage information is stored in a table T3, as shown in a region R14 of FIG. 11.

In S40, the server 50 generates an operation schedule of the refrigerator 20b. Specifically, the server 50 determines an operation mode of the refrigerator 20b for each time period. For example, as indicated in a region R15 of FIG. 11, though not being all of the users, the predetermined number (three) or more users have the attribute “not home” as the common schedule information in the time period determined in S20, thus the server 50 can determine that a frequency of opening and closing a door of the refrigerator 20b during this time period is less, and determines the operation mode thereof as an eco-operation mode, which is an operation mode with a low power consumption. Further, as indicated in a region R16, based on the power outage information obtained in S30, the server 50 determines the operation mode of the refrigerator 20b during a time period starting at a predetermined time (such as one hour) before a time when the power outage starts to a high-power operation mode, which is an operation mode that cools groceries inside the refrigerator 20b with high power so that a rise in a temperature of the groceries exceeding a predetermined level is prevented during the power outage. The server 50 determines the operation mode of the refrigerator 20b to a normal operation mode for time periods other than the aforementioned time period. As indicated in a region R17 of FIG. 11, common schedule information of the respective users “bedtime” may be obtained in S20. A time period during which all the users are in bed has a reduced frequency of using the refrigerator 20b, thus the server 50 may control the operation of the refrigerator 20b so as to execute automatic ice-making (region R18), that uses more power more than usual, in this time period. Then, in S50, the server 50 sends the generated operation schedule to the terminal device 100.

Since the refrigerator 20b is expected to operate at all times, the processes of S240 to S330 in the operation start standby process of FIG. 5 may not be executed. Further, the in-operation process of FIG. 7 may not be executed. Further, the processes of S40 and S50 (generation of the operation schedule and sending of the operation schedule) may be executed once a day (such as at 21:00 every day), for example.

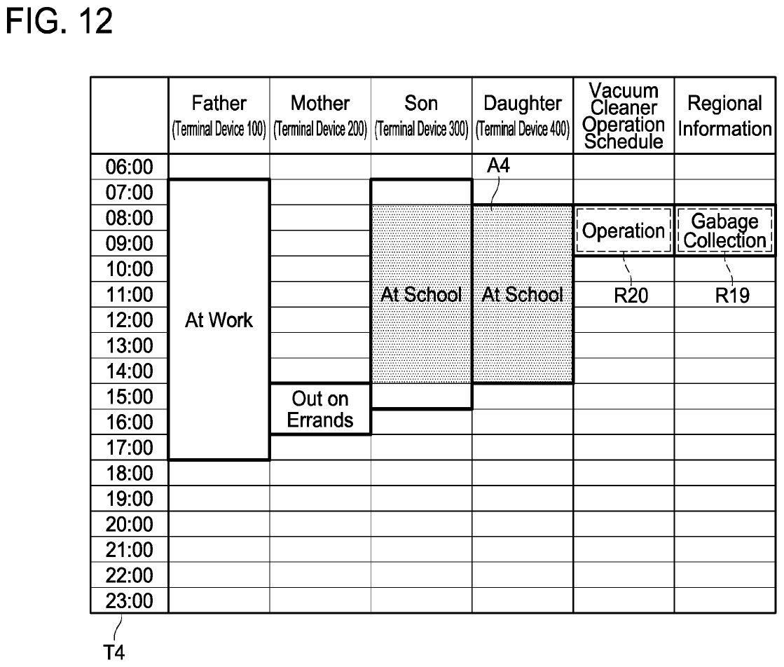

Further, in the aforementioned home appliance control system 10, the server 50 may control an operation of the vacuum cleaner 20c. In this case, in S20 of FIG. 3, the server 50 may extract a time period during which specific users have the attribute “not home” as the common schedule information. That is, S20 may be read as “extract a time period during which specific users are commonly “not home””. The specific users may for example be the children, namely the “son” and the “daughter”. Specifically, as shown for example in FIG. 12, 8:00 to 15:00, which is a time period during which all the children have the attribute “not home”, is extracted as the common schedule (i.e., a common area A4).

In S30, the server 50 obtains garbage collection information indicating a garbage collection time and a type of garbage to be collected as the external service information by using the external service information obtaining unit 62. The obtained garbage collection information is stored in a table T4, as indicated in a region R19 of FIG. 12.

In S40, the server 50 generates an operation schedule for the vacuum cleaner 20c. The vacuum cleaner 20c in this case is a so-called robot vacuum cleaner that is capable of autonomously moving and executing cleaning operation of areas. Specifically, the server 50 determines an operating time of the vacuum cleaner 20c. For example, as indicated in a region R20 of FIG. 12, since both children commonly have the attribute “not home” during the time period determined in S20, the server 50 determines the operation of the vacuum cleaner 20c to execute cleaning of children's rooms during this time period. In the example shown in FIG. 12, the server 50 determines a time period from 8:00 to 10:00 from the common area A4 as the operating time of the vacuum cleaner 20c. Then, in S50, the server 50 sends the generated operation schedule to the terminal device 100.

In the case of controlling the operation of the vacuum cleaner 20c, S260 of FIG. 5 may be omitted. Further, in S270, for example, the affirmative determination may be made in a case where all of the specific users (i.e., the children) have the attribute “not home”. Further, in S290, for example, the affirmative determination may be made in a case where one or more users have the attribute “not home”. Further, in S430 of FIG. 8, the server 50 may send information indicating a state in which the operation is stopped due to a floor height difference, and information indicating a state of cleaning a set route again, as the process information, for example.

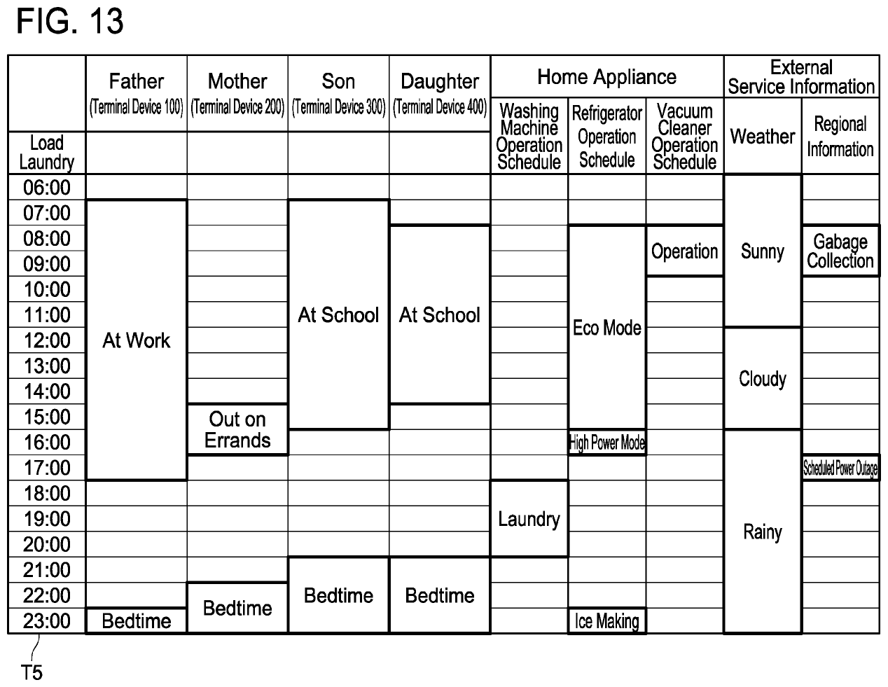

Further, in the above, configurations for controlling the respective operations of the washing machine 20a, the refrigerator 20b, and the vacuum cleaner 20c have been described. However, as shown in a table T5 of FIG. 13, the server 50 may generate an operation schedule for all of the washing machine 20a, the refrigerator 20b, and the vacuum cleaner 20c and collectively control their respective operations. Further, the server 50 may control operations of home appliances 20 other than the washing machine 20a, the refrigerator 20b, and the vacuum cleaner 20c.

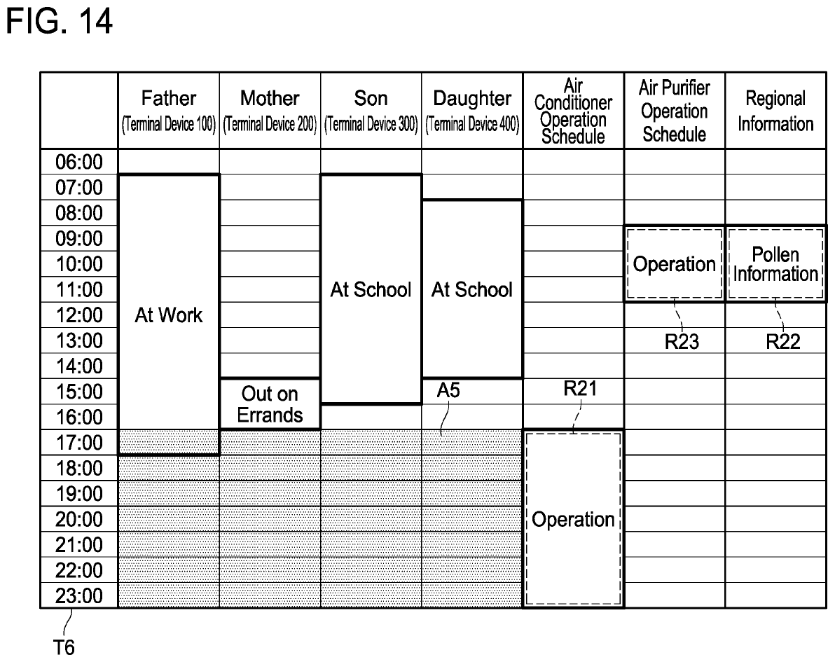

For example, in a case of controlling an operation of the air conditioner, the server 50 may control the air conditioner such that its operation is executed in a time period during which a predetermined number (such as three) or more users commonly have the attribute “at home” (i.e., a common area A5), as indicated in a region R21 in a table T6 of FIG. 14. To improve comfort of the users, the air conditioner may be controlled so that it starts its operation a predetermined time (such as one hour) before the time period in which the predetermined number or more of the users have the attribute “at home”. Further, in a case of controlling an operation of the air purifier, the server 50 may obtain pollen information indicating that an amount of pollens in the air is large as the external service information by using the external service information obtaining unit 62, as indicated in a region R22. In this case, the server 50 may control the air purifier to execute its operation during a time period in which the amount of pollens in the air indicated by the pollen information is large, as indicated in a region R23. The server 50 may obtain climatic information (not shown) such as temperature and humidity as the external service information, and may control a setting temperature of the air conditioner and the like based on the obtained climatic information.

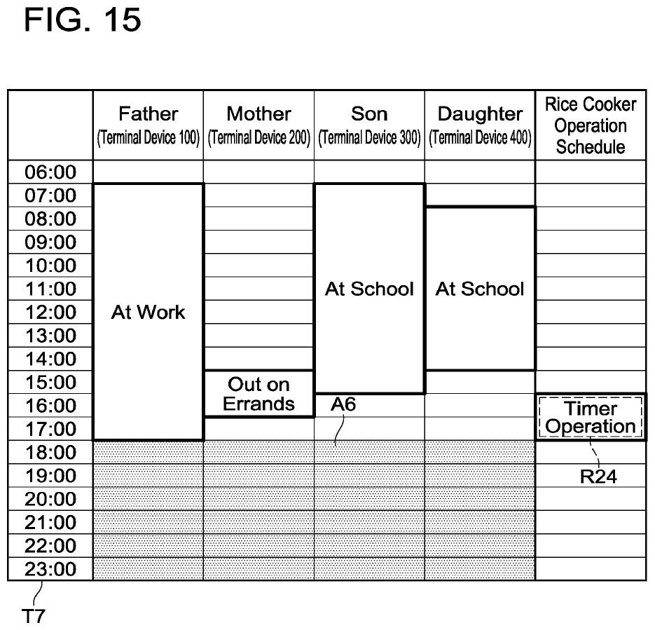

Further, in a case of controlling an operation of the rice cooker, the server 50 may respectively obtain time points when the attribute of the respective users changes from “not home” to “at home”, and may cause the rice cooker to execute a timer operation so that rice is ready at a latest time point among the obtained time points, as indicated in a region R24 of a table T7 of FIG. 15. In other words, the server 50 may cause the rice cooker to execute the timer operation so that the rice is ready at an earliest time point in the time period in which the attribute of all of the family becomes “at home” (i.e., the common area A6). For example, in a case where a change was made to the schedule information of the users such as a change in a time to come home (i.e., a time when the attribute changes from “not home” to “at home”), the server 50 may control the operation of the rice cooker so that the rice becomes ready based on the changed schedule information.

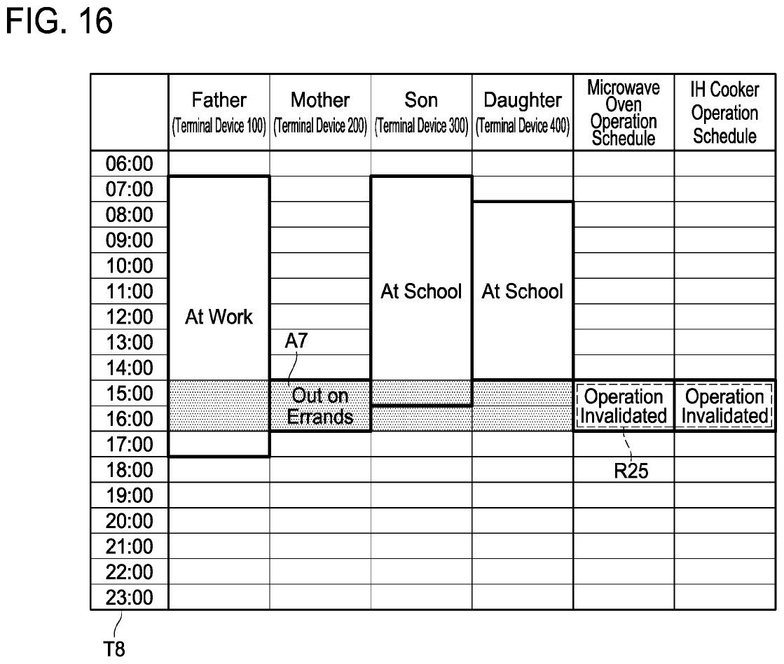

Further, in cases of controlling operations of the microwave oven or the IH cooker, the server 50 may control to restrict a user operation input in a case where only the children have the attribute “at home” (i.e., a time period during which the father and the mother have the attribute “not home” and the son and the daughter have the attribute “at home”) as indicated in a region R25 of a table T8 of FIG. 16. That is, as shown in FIG. 16, a common area A7 may be extracted as a time period during which only the children have the attribute “at home”, and a user operation inputted to the operation unit of the microwave oven or the IH cooker may be invalidated between 15:00 to 17:00 being this time period. According to such a configuration, an unexpected user operation to an operation unit of a home appliance 20 can be prevented in a situation where the adults are not at home.

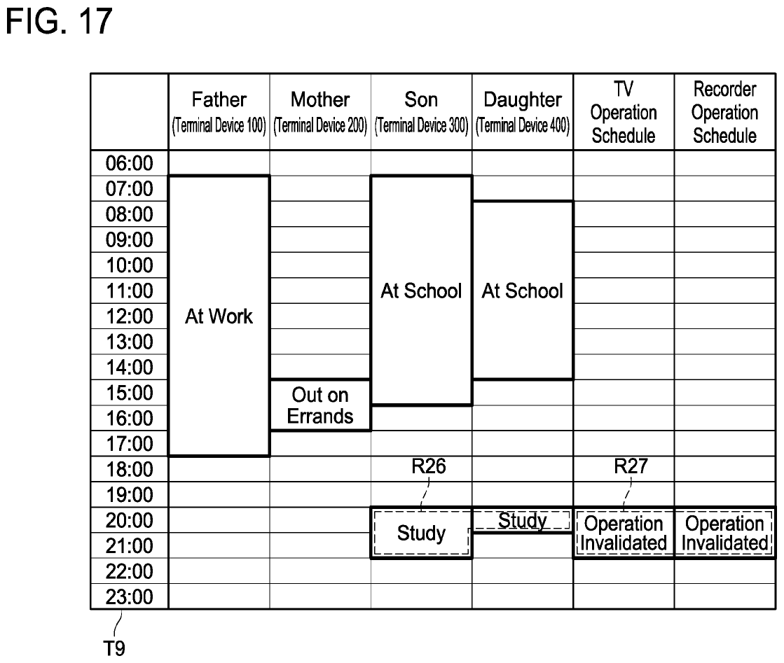

Further, in cases of controlling operations of the TV or the recorder, the server 50 may control to restrict a user operation input during a time period when schedule information “study” for the children (region R26) is registered, as indicated in a region R27 of a table T9 of FIG. 17. That is, a user operation inputted to the operation unit of the TV, the recorder, or a remote controller thereof may be invalidated. Further, as indicated in a region R28, in a time period late at night (such as after 22:00), the server 50 may control to limit a volume of the TV to prevent noise affecting neighbors.

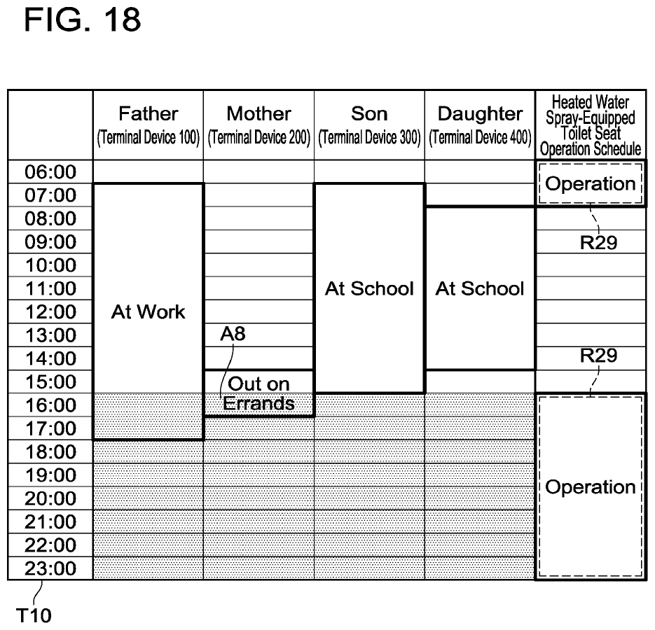

Further, in a case of controlling operation of the heated water spray-equipped toilet seat, the server 50 may control the heated water spray-equipped toilet seat to execute the operation in a time period in which a predetermined number (such as two) or more of the users has the attribute “at home” (i.e., a common area A8), as indicated in a region R29 of a table T10 of FIG. 18. Even during a time period in which the operation is not executed, the server 50 may control to cause the operation to be executed when the user(s) perform a user operation input to an operation unit of the heated water spray-equipped toilet seat.

In the aforementioned first embodiment, the processes of S30 and S50 shown in FIG. 3 may not be executed. Further, the processes of S210 to S310 and S330 shown in FIG. 5 may not be executed. Further, the in-operation process shown in FIG. 8 may not be executed. That is, in the aforementioned home appliance control system 10, the server 50 may at last execute the processes of S10 and S40 of FIG. 3 and S320 of FIG. 5.

Further, in S20, the time period in which all of the users have the attribute “at home” is extracted. However, a time period in which a predetermined number (such as two) or more users have the attribute “at home” may be extracted. Further, the attribute is used as the common schedule information for generating the operation schedule, however, the operation schedule may be generated by directly using the schedule information itself being a basis of the attribute.

Further, in the aforementioned first embodiment, the laundry loading information is stored in the scheduler 60 in response to each user's input operation to the image B4 shown in FIG. 6. However, it may be stored in the scheduler 60 in response to a user operation input to the operation unit 22 of the washing machine 20a.

Further, in the aforementioned first embodiment, the server 50 sends the generated operation schedule to the respective terminal devices 100 to 400. However, the server 50 may send the operation schedule to the washing machine 20a. The washing machine 20a may display the operation schedule received from the server 50 on the display unit 24. Further, the server 50 may send the generated operation schedule to a video device such as the TV and cause it to display the operation schedule. According to such a configuration, the operation schedule can suitably be proposed even to a user with low information literacy.

Further, each of the plurality of home appliances 20 may be provided with the server 50. That is, the server 50 may not be provided on the communication network but may be installed in each of the home appliances 20.

Further, in the aforementioned first embodiment, the server 50 sends the generated operation schedule to each of the terminal devices 100 to 400, however, it may send the same only to a terminal device of a specific user.

Further, each of the terminal devices 100 to 400 having received the schedule information of the plurality of users may be configured capable of controlling the operations of the plurality of home appliances 20.

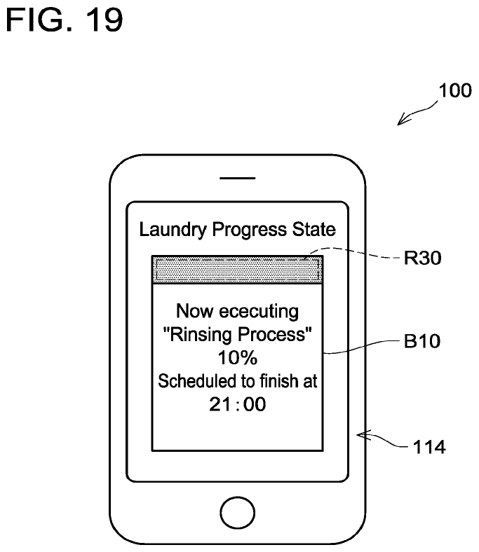

The display configurations shown in the drawings are mere examples, and other display configurations may be used. For example, when the degree information is received from the server 50 in S440 of FIG. 8, the terminal device 100 may indicate the degree of progress over the entire operation by changing a display configuration of a ratio of the image B10 displayed on the display unit 114 with respect to an entire area (a region R30 indicated by dot hatching) as shown in FIG. 19. For example, a color of the region R30 may be displayed in a color different from other regions. According to such a configuration, the users can visually recognize the degree of progress. Further, the terminal devices 100 to 400 may not be portable terminals, but may be stationary PCs and the like.

### Second Embodiment

Next, a home appliance control system of a second embodiment will be described. The configuration of the home appliance control system of the second embodiment is similar to FIG. 1 of the first embodiment. In the first embodiment, the washing machine 20a was exemplified to explain the control system of the home appliances 20 in general, but in this embodiment, an example of a control system that is dedicated to a unique feature of the washing machine 20a will be described. In the drawings described hereinbelow, elements that are same as those of the first embodiment are given same reference signs as the first embodiment.

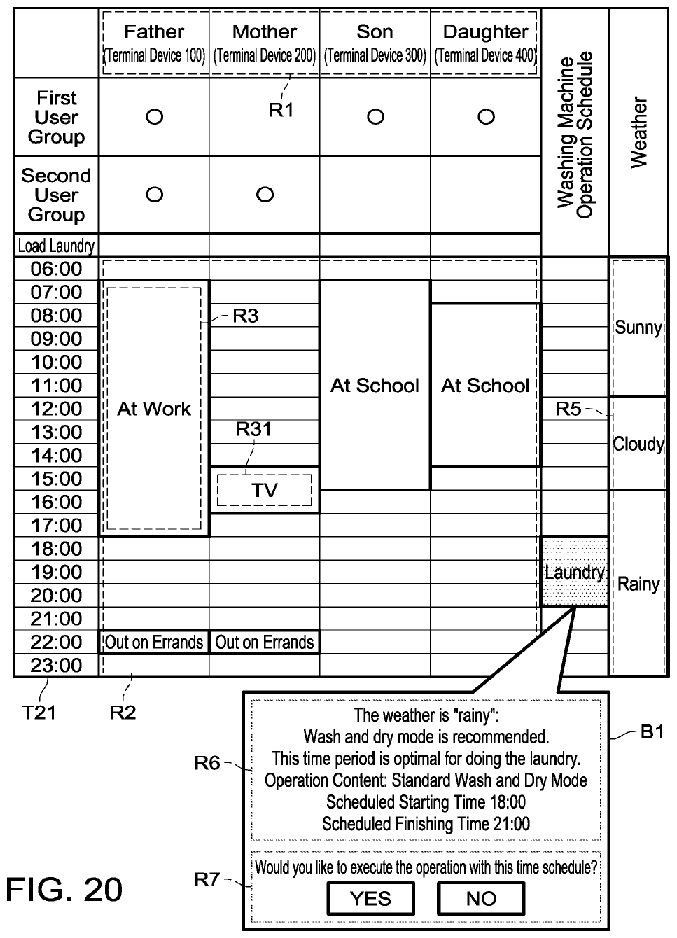

FIG. 20 shows an example of a table T21 in which schedule information is stored. In this embodiment, the schedule information further includes viewing schedule information indicating whether or not there is a program which a user plan to watch. “TV” indicated in a region R31 of FIG. 20 is the viewing schedule information, indicating that the mother is watching TV, and having the attribute “at home”. The “TV” in the schedule indicates that the user has the attribute “at home” but is unable to do the laundry.

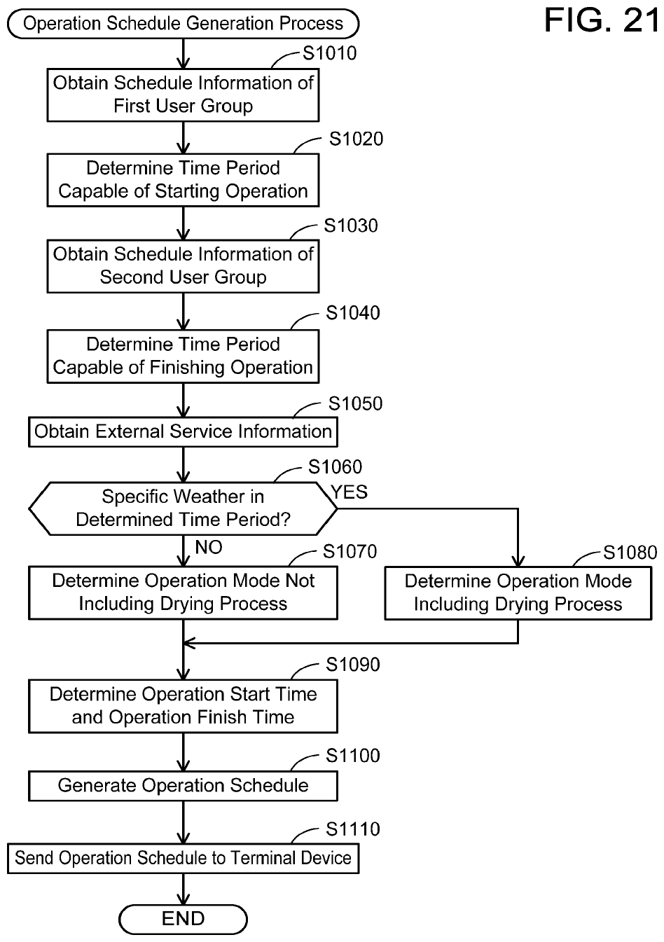

The respective processes which the server 50 executes will be described with reference to the drawings. Firstly, the operation schedule generation process by which the server 50 generates the operation schedule of the washing machine 20a will be described with reference to FIG. 21. The operation schedule generation process is initiated when the schedule information is sent to the scheduler by the user of each of the terminal devices 100 to 400.

In S1010, the server 50 obtains the schedule information of each user belonging to a first user group from the scheduler 60. In this embodiment, the users belonging to the first user group are users having schedules in which the attribute is “not home” during the daytime (such as between 9:00 to 18:00). Specifically, as shown for example in FIG. 20, the father having “at work” registered and the son and the daughter having “at school” registered correspond hereto. A user group may for example be set by the user operating the operation unit 112 of the terminal device 100. The schedule information which the server 50 obtained is stored in the table T21 as indicated in a region R3 of FIG. 20.

In S1020, the server 50 determines a time period in which the washing machine 20a can start operating. Specifically, firstly the server 50 extracts time points when the attribute of the respective users belonging to the first user group changes from “not home” to “at home”. Then, a time starting from the latest time point among the extracted time points is determined as the time period in which the operation can be started. Since each user is expected to put his/her laundry of that day into the laundry tub 30 after the user has come home from outside, the server 50 can determine the time starting from the time point when the last user came home (i.e., the time point when the attribute changes from “not home” to “at home”) as the time period in which the operation can be started. In this embodiment, as shown in FIG. 20, since the time point when the father comes home (18:00) is the latest among the time points the users belonging to the first user group come home, the server 50 determines the time starting from 18:00 as the time period in which the operation can be started.

In S1030, the server 50 obtains the schedule information of each user belonging to a second user group. In this embodiment, the users belonging to the second user group are users capable of performing laundry work (i.e., work to take out the laundry from the laundry tub 30 and work to hang the laundry). Specifically, as shown for example in FIG. 20, the father and the mother being the adults correspond hereto. The obtained schedule information is stored in the table T21 as indicated in a region R31 of FIG. 20. In this embodiment, since the schedule information of the father belonging to the first user group has already been obtained in S1010, the schedule information of the father may not be obtained in S1030.

In S1040, the server 50 determines a time period in which the operation of the washing machine 20a can be finished. Specifically, firstly the server 50 sets an earliest time point (that is, 18:00) in the time period in which the operation can be started as determined in S1020 as a candidate of the time period in which the operation can be finished. Then, in the candidate time period, a time period that is other than a time period in which all of the users belonging to the second user group have the attribute “not home” and other than a time period in which the viewing schedule information is registered is determined as the time period in which the operation can be finished. In this embodiment, as shown in FIG. 20, a time period excluding 22:00 to 23:00, which is the time period in which the father and the mother will be “not home”, is determined as the time period in which the operation can be finished. That is, 18:00 to 22:00 and 23:00 to 24:00 are each determined as the time period in which the operation can be finished. The time period in which the operation can be finished may be determined so as to include, from within the time period in which the attribute of hall of the users belonging to the second user group is “not home”, a time period starting a predetermined time before a timing when the attribute changes from “not home” to “at home” may be included.

S1050 is similar to S30 of FIG. 3. The obtained weather information is stored in the table T21 as indicated in a region R5 of FIG. 20. In S1060, the server 50 determines whether the weather indicated by the weather information during the operable time period is specific weather or not. Specifically, the server 50 determines whether the weather information during the operable time period (18:00 to 22:00 and 23:00 to 24:00) indicates “rainy” or not. The server 50 proceeds to S1070 in a case of an affirmative determination (YES to S1060), and proceeds to S1080 in a case of a negative determination (NO to S1060).

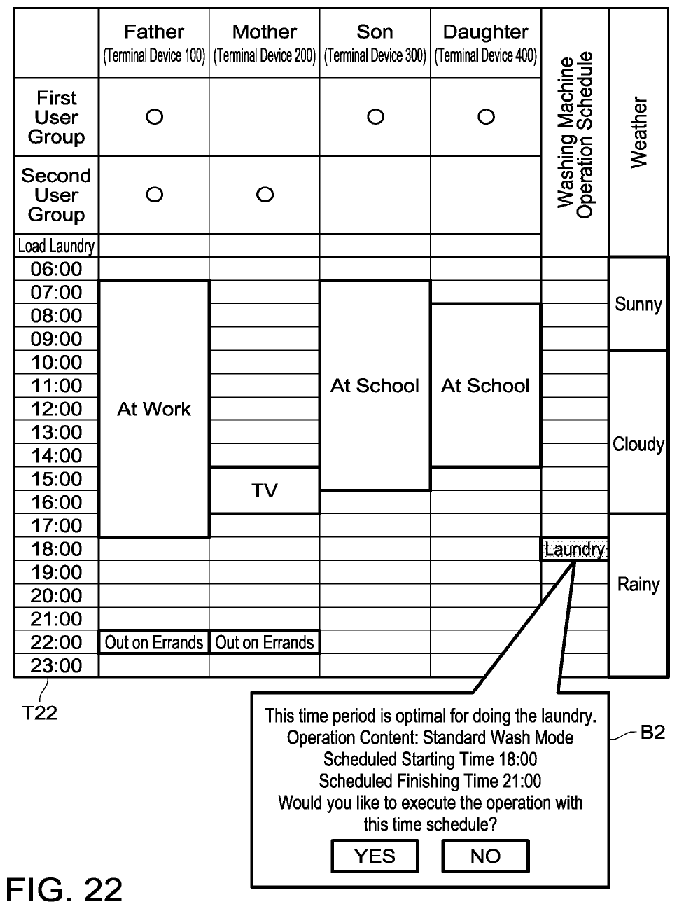

In S1070, the server 50 determines the operation content. Specifically, the server 50 determines the operation mode that combines processes such as the wash operation executing the washing process and the dry operation executing the drying process. In S1070, since the weather indicated by the weather information is not “rainy”, the operation mode not including the dry operation is determined. For example, in a table T22 shown in FIG. 22, the weather of the operable time period (18:00 to 22:00 and 23:00 to 24:00) indicates “sunny”, so the server 50 determines the operation mode not including the dry operation. FIGS. 20 and 22 indicate cases in which the weather indicated by the weather information is opposite from one another.

On the other hand, in S1080, since the weather indicated by the weather information is “rainy”, the server 50 determines the operation mode including the dry operation. For example, in the table T21 shown in FIG. 20, the weather of the operable time period (18:00 to 22:00 and 23:00 to 24:00) indicates “rainy”, so the server 50 determines the operation mode including the dry operation.

In S1090, the server 50 determines an operation start time and an operation finish time. In the present embodiment (being the example shown in FIG. 20), the server 50 determines the operation start time to be at 18:00 and the operation finish time to be at 21:00. Then, in S1100, the server 50 generates the operation schedule. The operation schedule is generated based on the operation content determined in S1070 or S1080 and the operation start time and the operation finish time determined in S1090.

In S1110, the server 50 sends the generated operation schedule to each of the terminal devices 100 to 400. The example shown in FIG. 20 is similar to FIG. 2, and the example shown in FIG. 22 is similar to FIG. 4. In S1110, the server 50 may send the generated operation schedule only to the terminal device 100 of the father and the terminal device 200 of the mother who are set as the users capable of performing the laundry work (i.e., the users belonging to the second user group). When the process of S1110 is executed, the server 50 terminates the operation schedule generation process.

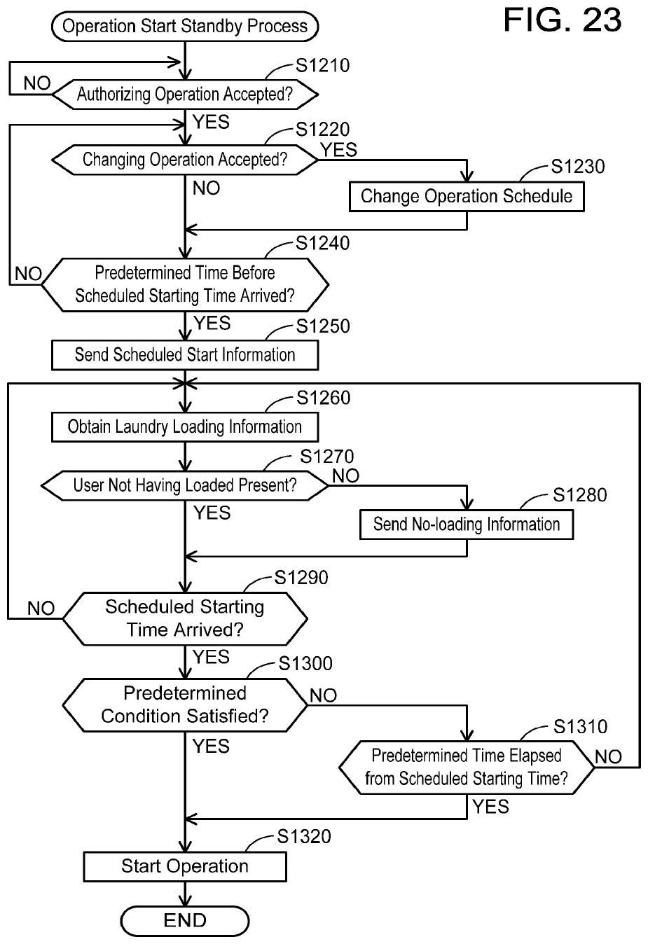

Next, the operation start standby process will be described with reference to FIG. 23. S1210, S1220, and 51230 are respectively similar to S210, S220, and S230 of FIG. 5. In S1220, an affirmative determination may be made in a case of determining that an input of operation to change the operation has been directly accepted by the operation unit 22 of the washing machine 20a.

In S1240, the server 50 determines whether or not a time point that is a predetermined time before the scheduled starting time has arrived. The predetermined time is set for example to 10 minutes. In this embodiment, as aforementioned, since the scheduled starting time is set at 18:00, the server 50 determines whether or not 17:50 has arrived. The server 50 proceeds to S1250 in a case of an affirmative determination (YES to S1240), and returns to S1220 in a case of a negative determination (NO to S1240).

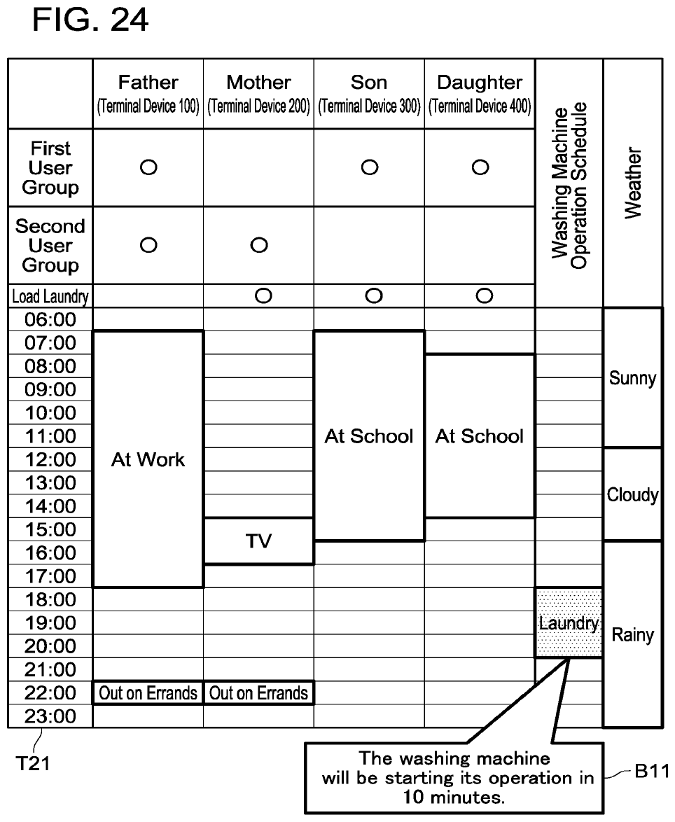

In S1250, the server 50 sends scheduled start information to the terminal device 100. The scheduled start information is information indicating a time when the operation according to the operation schedule is to be started. When the scheduled start information is received from the server 50, the terminal device 100 displays an image B11 for notifying the user of the scheduled time when the operation is to start on the display unit 114 as shown for example in FIG. 24.

S1260 is similar to S260 of FIG. 5. In S1270, the server 50 determines whether or not there is a user who has not yet loaded his/her laundry based on the laundry loading information. The server 50 proceeds to S1280 in a case of an affirmative determination (YES to S1270), and proceeds to S1290 in a case of a negative determination (NO to S1270).

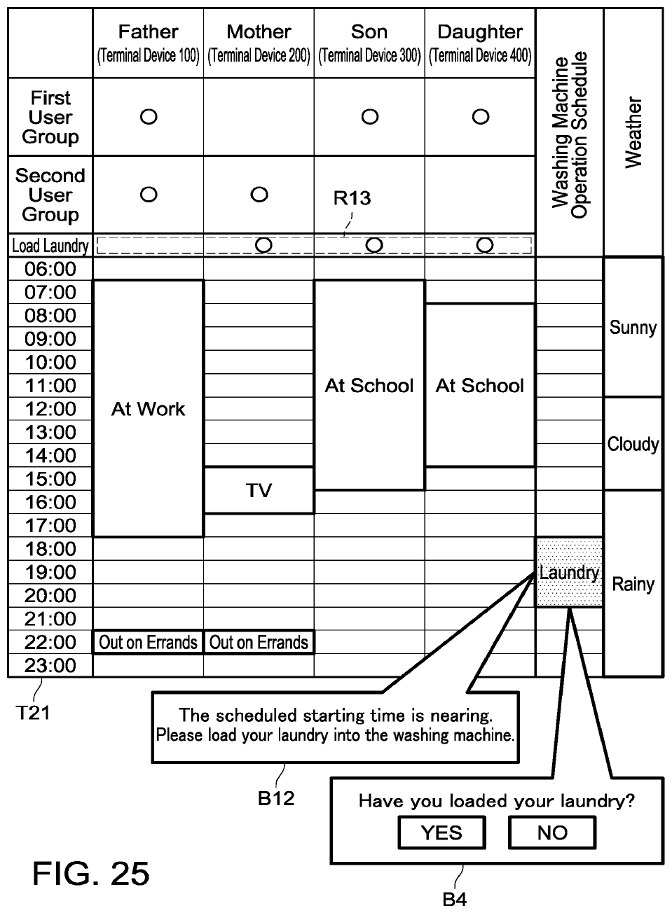

In S1280, the server 50 sends load-reminding information to the terminal device of each user who is determined as not having loaded his/her laundry based on the laundry loading information. The load-reminding information is information indicating that the laundry has not been loaded yet. Specifically, in a case where the user of the terminal device 100 has not loaded his laundry, an image B12 for notifying the user that the laundry has not been loaded is displayed on the display unit 114 of the terminal device 100 as shown for example in FIG. 25.

In S1290, the server 50 determines whether or not the scheduled starting time according to the operation schedule has arrived. In this embodiment, it is determined whether 18:00, which is the scheduled starting time, has arrived. The server 50 proceeds to S1300 in a case of an affirmative determination (YES to S1290) and returns to S1260 in a case of a negative determination (NO to S1290). The process of S1290 may be skipped in a case of a negative determination in S1310 to be described later.

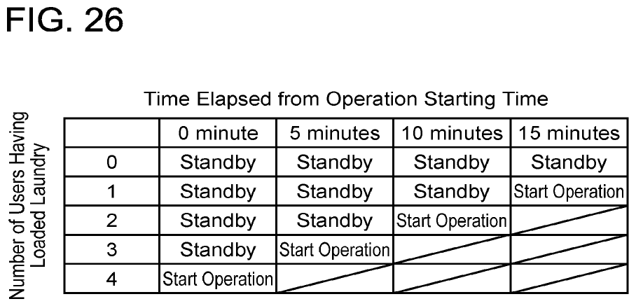

In S1300, the server 50 determines whether or not a predetermined condition is satisfied based on the laundry loading information. The predetermined condition may for example be defined by a number of users who have loaded the laundry with respect to a time having elapsed from the scheduled starting time. Specifically, as shown in FIG. 26, the operation of the washing machine 20a is started in a case where a predetermined number or more users have loaded the laundry at a timing when a predetermined time has elapsed from the scheduled starting time. For example, in a case where 5 minutes has elapsed from the scheduled starting time, the operation of the washing machine 20a is started when three or more users have loaded the laundry. The server 50 proceeds to S1320 in a case of an affirmative determination (YES to S1300) and proceeds to S1310 in a case of a negative determination (NO to S1300).

In S1310, the server 50 determines whether or not a predetermined time has elapsed from the scheduled starting time according to the operation schedule. The predetermined time is set for example to 30 minutes. In this embodiment, since the scheduled starting time is determined as 18:00, the server 50 determines whether or not 18:30 has arrived. The server 50 proceeds to S1320 in a case of an affirmative determination (YES to S1310), and returns to S1260 in a case of a negative determination (NO to S1310). S1320 is similar to S320 of FIG. 5. When the process of S320 is executed, the server 50 terminates the operation start standby process.

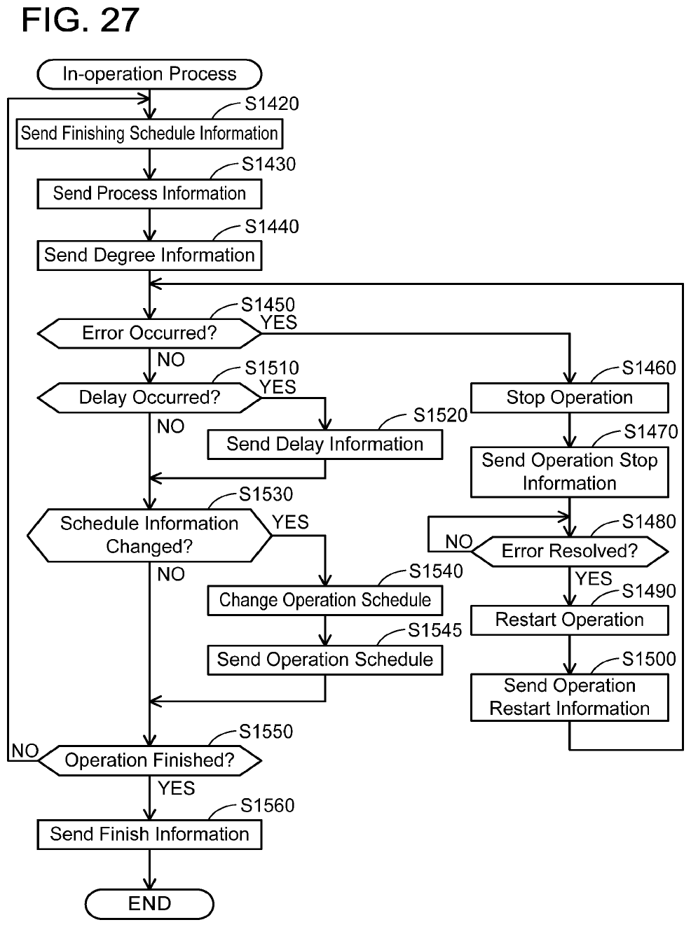

Next, the in-operation process will be described with reference to FIG. 27. The in-operation process is a process executed after the operation according to the operation schedule has been started. The in-operation process is executed after the process of S1320 of the drawing (i.e., start of the operation of the washing machine 20a) has been executed.

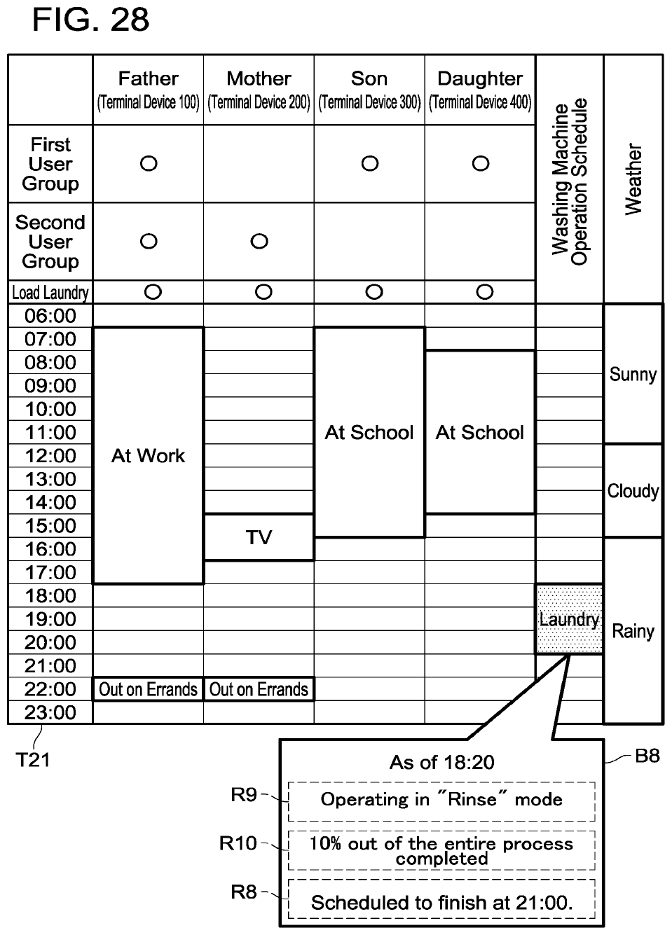

S1420 to S1440 are respectively similar to S420 to S440 of FIG. 8. The processes of S1420 to S1440 may be executed once every predetermined time while the washing machine 20a is executing the operation, or may be executed at arbitrary timings. Further, letter string images shown respectively in regions R8, R9, R10 of FIG. 28 may be displayed as separate images.

In S1450, the server 50 determines whether or not an error has occurred in the operation of the washing machine 20a. The error may for example be unbalanced laundry inside the laundry tub 30 or a water drainage problem. The server 50 proceeds to S1460 in a case of an affirmative determination (YES to S1450), and proceeds to S1510 in a case of a negative determination (NO to S1450).

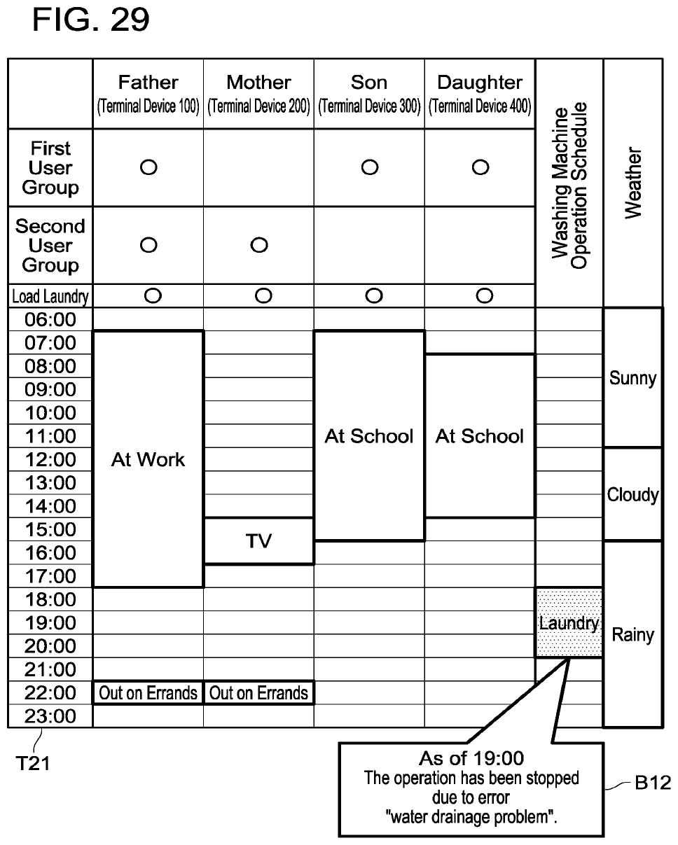

In S1460, the server 50 stops the operation of the washing machine 20a. Then, in S1470, the server 50 sends operation stop information to the terminal device 100. The operation stop information is information indicating that the operation of the washing machine 20a was automatically stopped due to an occurrence of an error. When the operation stop information is received from the server 50, the terminal device 100 displays an image B12 for notifying the user that the operation of the washing machine 20a according to the operation schedule was automatically stopped as shown for example in FIG. 29.

In S1480, the server 50 determines whether or not the error has been resolved. Specifically, it determines whether or not the unbalanced laundry in the laundry tub 30 or the water drainage problem being the error has been resolved by user's operation. The server 50 proceeds to S1490 in a case of an affirmative determination (YES to S1480), and repeats S1480 in a case of a negative determination (NO to S1480).

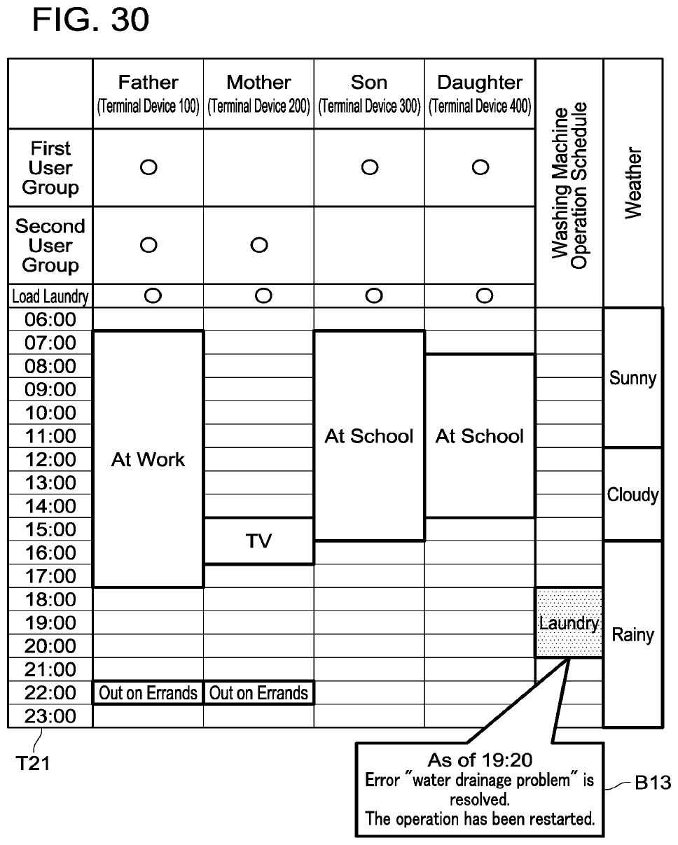

In S1490, the server 50 restarts the operation of the washing machine 20a. Then, in S1500, the server 50 sends operation restart information to the terminal device 100. The operation restart information is information indicating that the operation of the washing machine 20a has been restarted. When the operation restart information is received from the server 50, the terminal device 100 displays an image B13 for notifying the user that the operation of the washing machine 20a has been restarted as shown for example in FIG. 30. When the process of S1500 is executed, the server 50 returns to S1450.

In S1510, which is the case of NO to S1450, the server 50 determines whether or not a delay is occurring in the operation according to the operation schedule. Specifically, the server 50 determines whether or not an expected finishing time of the operation according to the operation schedule is delayed from the scheduled finishing time indicated by the finishing schedule information due to the occurrence of the error. For example, as aforementioned in this embodiment, while the operation of the washing machine 20a is scheduled to finish at 21:00 according to the operation schedule, a determination is made on whether or not the expected finishing time will be later than 21:00 due to the occurrence of the delay. The server 50 proceeds to S1520 in a case of an affirmative determination (YES to S1510), and proceeds to S1530 in a case of a negative determination (NO to S1510).

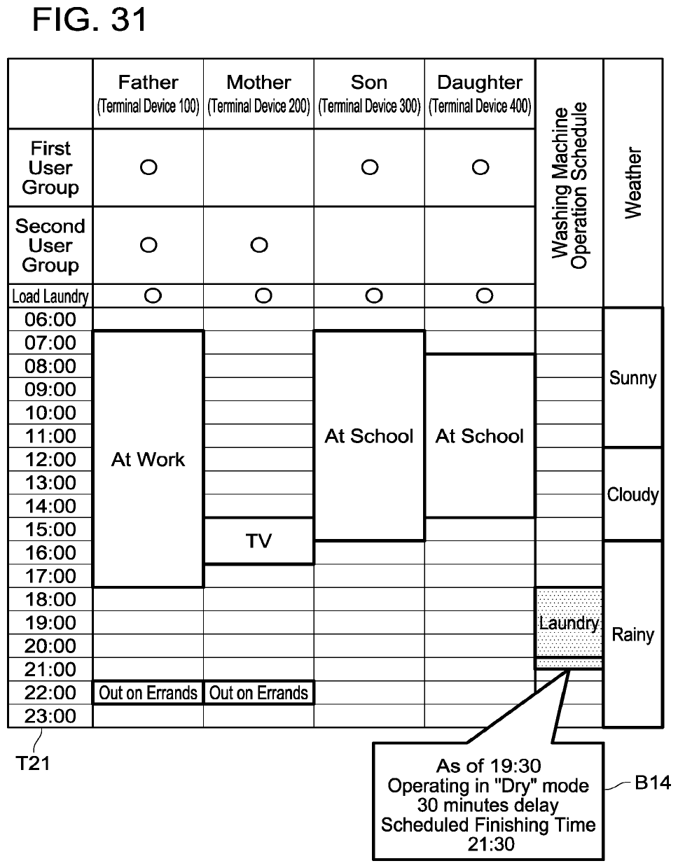

In S1520, the server 50 sends delay information to the terminal device 100. The delay information is information indicating that a delay is occurring in the operation of the washing machine 20a according to the operation schedule and a new scheduled finishing time that takes a delayed time into account. When the delay information is received from the server 50, the terminal device 100 displays an image B14 for notifying the user that the delay is occurring and the new scheduled finishing time that takes the delayed time into account as shown for example in FIG. 31.

In S1530, the server 50 determines whether or not the schedule information of the users belonging to the second user group has changed. In detail, a determination is made on whether or not all the users belonging to the second user group become “not home” at the scheduled finishing time of the operation of the washing machine 20a according to the operation schedule due to the schedule information of the users belonging to the second user group having been changed. The server 50 proceeds to S1550 in a case of an affirmative determination (YES to S1530), and proceeds to S1540 in a case of a negative determination (NO to S1530).

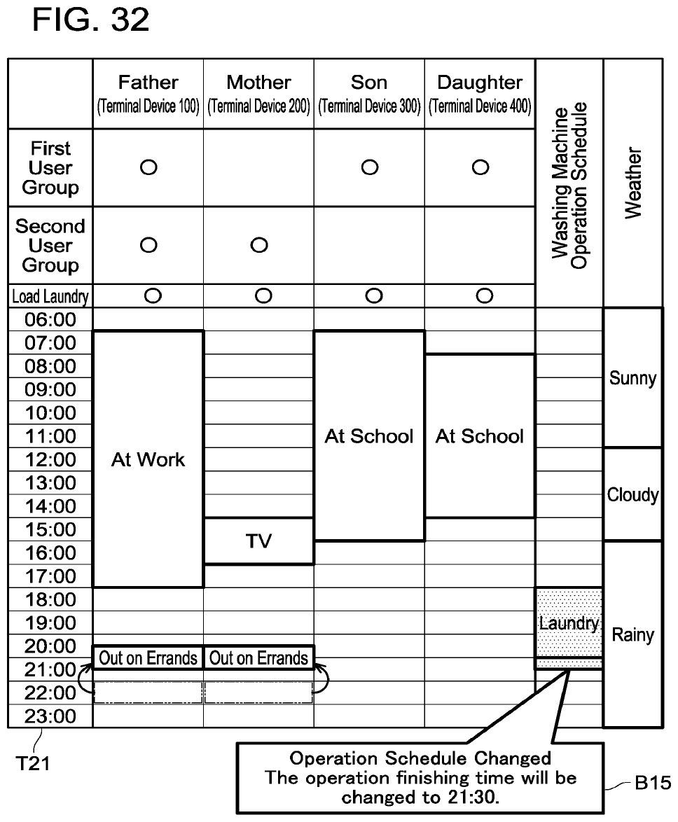

In S1540, the server 50 changes the operation schedule. For example, as shown in a table T21 of FIG. 32, in a case where the “out on errands” schedule that was registered between 22:00 to 23:00 in the schedule information of the father and the mother (being the users belonging to the second user group) (e.g., see the table T21 of FIG. 31) is changed to 20:30 to 21:30, both the father and the mother would have the attribute “not home” at the scheduled finishing time of the operation of the washing machine 20a. As such, in such a case, the server 50 changes the operation schedule, for example, so that the operation finish time of the washing machine 20a is changed to 21:30.

In S1545, the server 50 sends the changed operation schedule to the terminal device 100. When the changed operation schedule is received from the server 50, the terminal device 100 displays an image B15 for notifying the user that the operation schedule has been changed and the new scheduled finishing time as shown for example in FIG. 32.

S1550 is similar to S550 of FIG. 8. S1560 is similar to S560 of FIG. 8 (see FIG. 10). After having executed the process of S1560, the server 50 may generate the operation schedule for controlling the operation of the washing machine 20a for next time, and send the generated operation schedule to the terminal device 100 similar to the first embodiment.

(Effects)

In the home appliance control system of the present embodiment, the operation schedule is generated so that the operation is finished at a timing when the second user group has the attribute “at home” (S1040), so work to take out the finished laundry can smoothly be performed.

Further, in the case of having accepted the input of the operation to change the operation according to the operation schedule to the operation unit 22 (S1220), the washing machine 20a can execute the operation according to the changed operation schedule (S1320).

Further, the server 50 sends the operation stop information to each of the terminal devices 100 to 400 (S1470) in the case where the error occurs in the operation of the washing machine 20a (YES to S1450). Due to this, the users of the respective terminal devices 100 to 400 can acknowledge that the operation of the washing machine 20a had automatically stopped due to the occurrence of the error. Further, the server 50 sends the operation restart information to each of the terminal devices 100 to 400 in the case where the error is resolved (YES to S1480). Due to this, the users of the respective terminal devices 100 to 400 can remotely acknowledge that the error has been resolved.

Further, the server 50 sends the delay information to each of the terminal devices 100 to 400 (S1520) in the case where the delay is occurring in the operation of the washing machine 20a (YES to S1510). Due to this, the users of the respective terminal devices 100 to 400 can remotely acknowledge that the delay is occurring in the operation of the washing machine 20a.

Further, the server 50 obtains the laundry loading information from the scheduler 60 (S1260). Then, it causes the washing machine 20a to execute the operation (S1320) according to the number of users having loaded the laundry with respect to the time having elapsed from the scheduled starting time (i.e., the predetermined condition) (S1300). According to this, the laundry operation can efficiently be executed by setting the operation to standby until a predetermined amount of the laundry has been collected despite the operation start time having already arrived.

Further, even in the case where the predetermined condition is not satisfied (NO to S1300), the server 50 causes the washing machine 20a to execute the operation (S1320) in the case where the predetermined time has elapsed from the scheduled starting time (Yes to S1310).

The washing machine 20a may be caused to execute the operation in a case where the predetermined amount of the laundry is not collected despite having waited for the predetermined time from the scheduled starting time.

Further, the server 50 sends the load-reminding information (S1280) to the terminal device (being the terminal device 100 in this embodiment) of the user who is determined as not having loaded his/her laundry. Due to this, the users forgetting to load the laundry can be suppressed.

Further, the server 50 sends the scheduled start information to the respective terminal devices 100 to 400 (S1250) in the case where the time that is predetermined time before the scheduled starting time has arrived (YES to S1240). Due to this, even in cases where the users have forgotten to load his/her laundry or have forgotten the operation schedule, they can be reintroduced to the operation schedule.

Further, in the case where all the users belonging to the second user group become “not home” at the scheduled finishing time of the operation of the washing machine 20a according to the operation schedule due to the schedule information of the users belonging to the second user group having been changed (YES to S1530), the server 50 changes the operation schedule (S1540) so that the operation of the washing machine 20a will be finished at the timing when the users belonging to the second user group become “at home”. Since the operation schedule is changed so that the operation of the washing machine 20a finishes in the state where the users who are to perform the laundry work are home, a situation in which the laundry must be washed again due to wrinkles and damp-drying of the laundry caused by having been left neglected for a long time after finishing the operation can be suppressed.

(Corresponding Relationship)

“At work”, “at school”, and “out on errands” are examples of “presence information”. The “TV” is an example of “viewing schedule information”. The users belonging to the second user group are examples of a “first specific user”. The user operation to change the operation inputted to the operation unit 22 of the washing machine 20a is an example of a “fourth user operation”. The rainy weather is an example of “specific weather”.

(Variants)

In the aforementioned second embodiment, the operation start standby process shown in FIG. 23 and the in-operation process shown in FIG. 27 may not be executed. Further, the process of S1050 shown in FIG. 21 may not be executed.

Further, in S1020, the time period in which the washing machine 20a can start its operation is determined by extracting the time when the attribute of each of the users belonging to the first user group changes from “not home” to “at home”. However, a time starting from a latest time among the sets of time when “not home” changes to “at home” for a predetermined number (e.g., two) or more of the users may be determined as the time period in which the operation can be started.

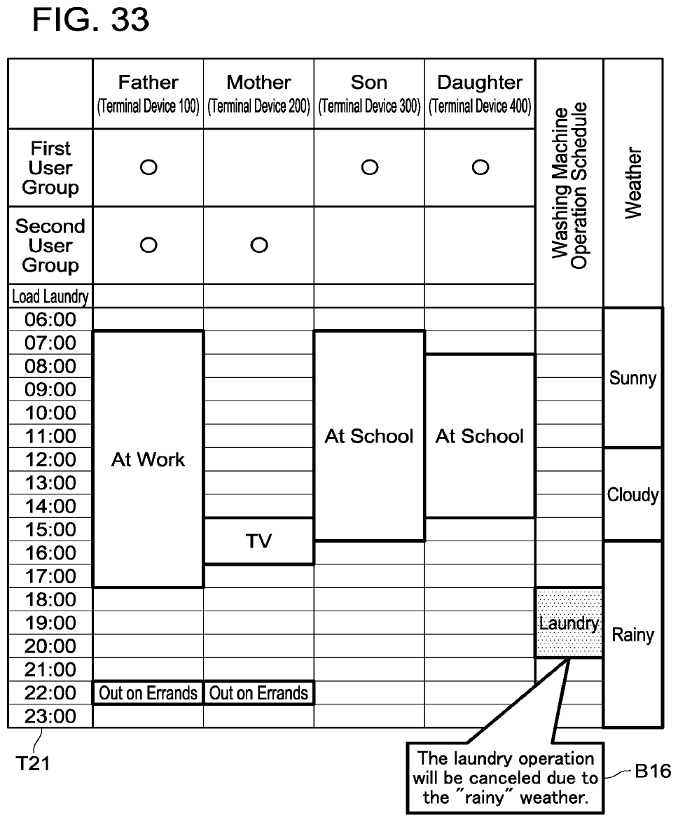

Further, in the aforementioned second embodiment, the server 50 determines the operation mode including the dry operation in S1080 in the case of determining in S1060 that the specific weather (i.e., “rainy”) is forecasted, and generates the operation schedule using the operation mode including the dry operation in S1100. However, in the case of determining in S1060 that the specific weather is forecasted, the server 50 may generate an operation schedule that cancels the operation of the washing machine 20a. That is, in the case of the affirmative determination in S1060, S1080 and S1090 may be skipped, and the operation schedule that does not cause the washing machine 20a to execute the operation may be generated in S1100. In this case, when the operation schedule is received from the server 50 in S1110, the terminal device 100 may display an image B16 notifying the user that the operation of the washing machine 20a will be cancelled as shown for example in FIG. 33.

Further, in the aforementioned second embodiment, the case in which the specific weather is “rainy” has been described. However, the specific weather may be “snowy” or “sleety”. That is, it may be any weather in which doing the laundry would be difficult.

Further, in cases where the spinning process and the drying process are included in the determined operation mode, the server 50 may generate the operation schedule such that the washing machine 20a is caused to execute these processes at a timing when the attribute of all of the users (i.e., the father, mother, son, and daughter) us “not home”. Generally, the spinning process and the drying process have louder operation sounds as compared to other processes. Due to this, by executing these processes at the timing when the attribute of all of the users is “not home”, stress on the users caused by the operation sound can be reduced. In this embodiment, the washing process and the rinsing process are examples of a “first operation” and the spinning process and the drying process are examples of a “second operation”.

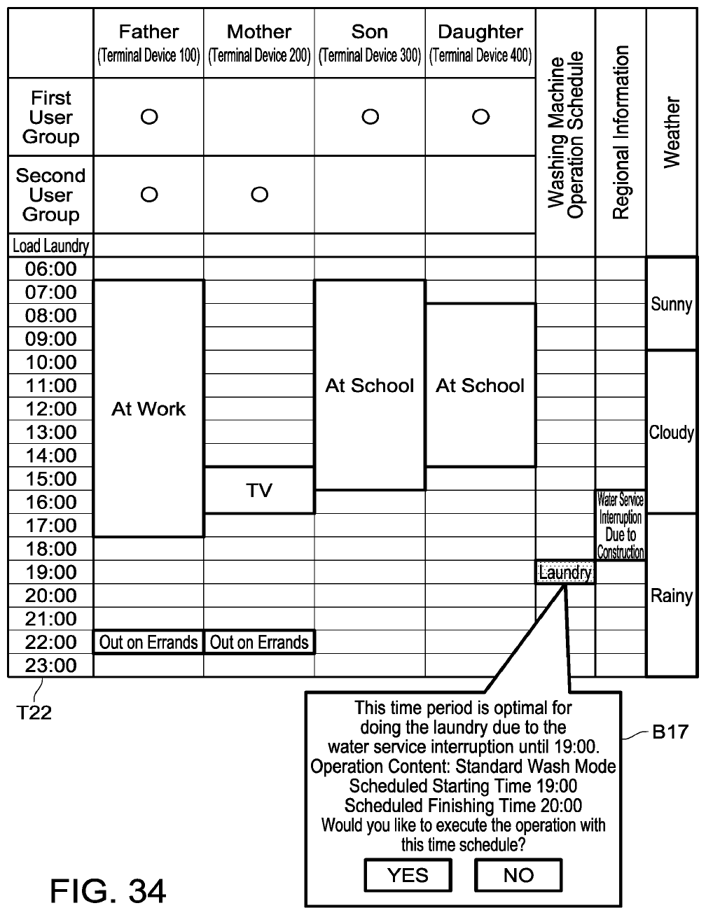

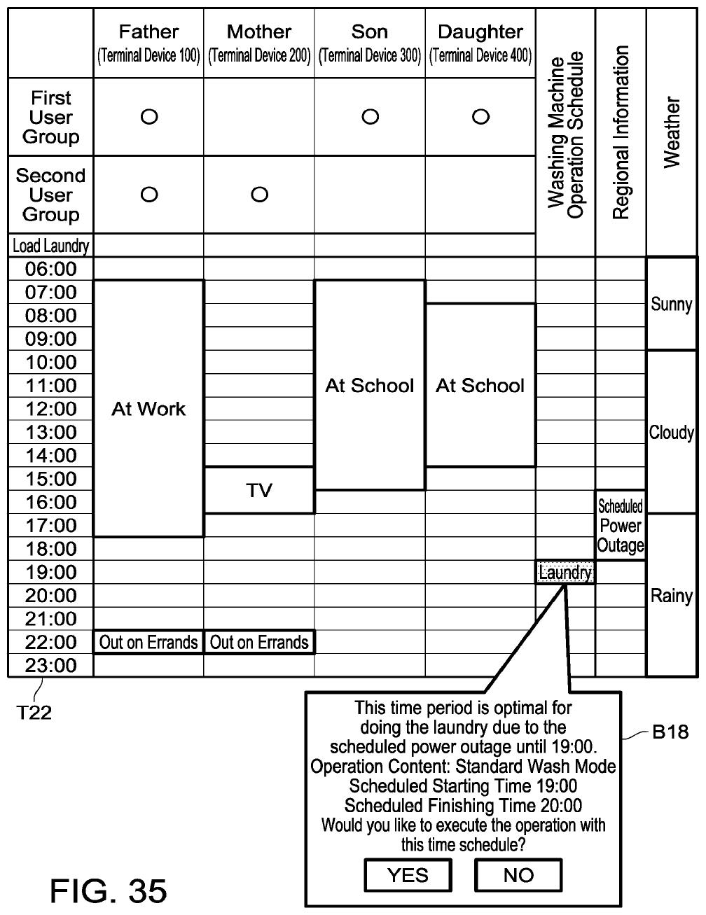

Further, in the aforementioned second embodiment, the external service information obtained in S1050 is the weather information. However, water service interruption information indicating a water service interruption plan, and power outage information indicating a power outage plan may be used as the external service information. In a case of using the water service interruption information, the server 50 may generate the operation schedule that does not cause the washing machine 20a to execute the operation during water service interruption. The terminal device 100 having received this operation schedule may display an image B17 for proposing the operation schedule that does not cause the washing machine 20a to execute the operation during the water service interruption as shown for example in FIG. 34. Further, in a case of using the power outage plan, the server 50 may generate the operation schedule that does not cause the washing machine 20a to execute the operation during power outage. The terminal device 100 having received this operation schedule may display an image B18 for proposing the operation schedule that does not cause the washing machine 20a to execute the operation during the power outage as shown for example in FIG. 35. As the external service information, a combination of the weather information, the water service interruption information, and the power outage information may be used.

Further, the user operation input to the operation unit 22 of the washing machine 20a may be restricted in the case where only the children have the attribute “at home” (i.e., the time period in which the father and the mother have the attribute “not home” while the son and the daughter have the attribute “at home”). That is, the user operation may be invalidated even if such is inputted to the operation unit 22 (a so-called child lock). For example, in the example shown in FIG. 20, since only the children have the attribute “at home” between 22:00 and 23:00, the user operation input to the operation unit 22 may be restricted. According to such a configuration, an unexpected user operation to the operation unit 22 can be prevented in a situation where the adults are not at home. In this embodiment, the son and the daughter are examples of a “second specific user”.

Further, in the aforementioned embodiments, the server 50 sends the generated operation schedule to each of the terminal devices 100 to 400. However, the server 50 may send the operation schedule to the washing machine 20a. The washing machine 20a may display the operation schedule received from the server 50 on the display unit 24. Further, the server 50 may send the generated operation schedule to a video device such as the TV and cause it to display the operation schedule.

Specific examples of the present invention have been described in detail, however, these are mere exemplary indications and thus do not intend to limit the scope of the claims. These examples may be implemented in various other configurations, and various omissions, substitutions, and modifications can be made within the scope that does not deviate from the essence of the invention. Such examples and variants are encompassed by the scope and essence of the invention, and are encompassed by the inventions recited in the claims and equivalents thereof.

### REFERENCE SIGNS LIST

10: Home Appliance Control System
20: Home Appliance
20a: Washing Machine
20b: Refrigerator
20c: Vacuum Cleaner
22: Operation Unit
24: Display Unit
26: Control Unit
30: Laundry Tub
50: Cloud Server
60: Scheduler
62: External Service Information Obtaining Unit
100: Terminal Device
110: Communication Network
112: Operation Unit
114: Display Unit
116: Control Unit
120: OS Program
122: Home Appliance Application
200, 300, 400: Terminal Device

1. A home appliance control system comprising:
at least one home appliance;
a server capable of communicating with the at least one home appliance and configured to control an operation of the at least one home appliance;
a scheduler stored in the server and configured to store each of schedule information of a plurality of users; and
terminal devices capable of accessing the scheduler,
wherein
the terminal devices are capable of sending the schedule information to the scheduler, and
the server is capable of controlling the operation of the at least one home appliance based on common schedule information among the schedule information of the users stored in the scheduler.

2. The home appliance control system of claim 1, wherein
each of the terminal devices is capable of receiving the schedule information of the users from the server and controlling the operation of the at least one home appliance based on the common schedule information among the received schedule information of the users.

3. The home appliance control system of claim 1, wherein
each of the schedule information includes attribute information which indicates a status of corresponding one of the users, and
the server controls the operation of the at least one home appliance based on the attribute information common to a predetermined number or more of the users as the common schedule information.

4. The home appliance control system of claim 3, wherein
each of the attribute information is presence information which indicates whether corresponding one of the users is at home or not, and
in a case where the server determines that a predetermined number or more of the users is at home based on the respective presence information, the server causes the at least one home appliance to execute the operation.

5. The home appliance control system of claim 3, wherein
each of the attribute information is presence information which indicates whether corresponding one of the users is at home or not, and
in a case where the server determines that a predetermined number or more of the users is not home based on the respective presence information, the server causes the at least one home appliance to execute the operation.

6. The home appliance control system of claim 1, wherein
the server generates an operation schedule for controlling the operation of the at least one home appliance based on the common schedule information of the users and sends the generated operation schedule to the terminal devices.

7. The home appliance control system of claim 6, wherein
the server is capable of obtaining external service information and generates the operation schedule for controlling the operation of the at least one home appliance based on the common schedule information of the users and the external service information.

8. The home appliance control system of claim 6, wherein
each of the terminal devices comprises a display unit,
in a case where the terminal devices receive the operation schedule from the server, each of the terminal devices displays a screen on the display unit for accepting a first user operation for selecting whether or not to cause the at least one home appliance to execute the operation according to the operation schedule, and
in a case where the server determines that the first user operation selecting to cause the at least one home appliance to execute the operation according to the operation schedule is accepted, the server controls the operation of the at least one home appliance according to the operation schedule.

9. The home appliance control system of claim 6, wherein
each of the terminal devices comprises a display unit,
in a case where the terminal devices receive the operation schedule from the server, each of the terminal devices displays a screen on the display unit for accepting a second user operation for changing the operation schedule, and
in a case where the server determines that the second user operation for changing the operation schedule is accepted, the server controls the operation of the at least one home appliance according to a changed operation schedule.

10. (canceled)

11. The home appliance control system of claim 6, wherein
the server causes the at least one home appliance to execute the operation according to the operation schedule in a case where the server determines that an executable condition is satisfied, the executable condition indicating whether or not the at least one home appliance is able to execute the operation according to the operation schedule.

12. The home appliance control system of claim 11, wherein
in a case where the server determines that the executable condition is not satisfied, the server sends predetermined information indicating a condition to satisfy the executable condition to the terminal devices.

13. The home appliance control system of claim 12, wherein
the server controls a state of the at least one home appliance in a standby state in a case where the server determines that the executable condition is not satisfied and that a predetermined condition regarding a number of the users based on the common schedule information of the users is satisfied.

14. The home appliance control system of claim 12, wherein
in a case where the server determines that the executable condition is not satisfied, the server causes each of the terminal devices to display a screen on a display unit of the terminal device for accepting a third user operation for selecting whether or not to cause the at least one home appliance to execute the operation according to the operation schedule, and
in a case where the server determines that the third user operation selecting to cause the at least one home appliance to execute the operation according to the operation schedule is accepted, the server causes the at least one home appliance to execute the operation according to the operation schedule.

15. The home appliance control system of claim 6, wherein
the at least one home appliance is a washing machine,
each of the schedule information includes presence information which indicates whether corresponding one of the users is at home or not, and
the server generates the operation schedule based on the presence information such that the operation of the washing machine finishes at a timing when a first specific user among the users is at home, and sends the operation schedule to the terminal device of the first specific user.

16. (canceled)

17. The home appliance control system of claim 15, wherein
the washing machine comprises an operation unit for accepting an input of a fourth user operation for changing the operation schedule, and
in a case where the input of the fourth user operation for changing the operation schedule is accepted, the washing machine generates a changed operation schedule.

18-21. (canceled)

22. The home appliance control system of claim 15, wherein
the server is capable of obtaining laundry loading information which respectively indicates whether or not the users have loaded their laundry into a laundry tub of the washing machine, and
in a case where the server determines that the predetermined condition regarding a number of the users who have loaded the laundry is satisfied based on the laundry loading information, the server causes the washing machine to execute the operation according to the operation schedule.

23. The home appliance control system of claim 22, wherein
the server causes the washing machine to execute the operation according to the operation schedule in a case where the server determines that the predetermined condition is not satisfied and that a predetermined time has elapsed since a scheduled starting time of the operation based on the operation schedule.

24. (canceled)

25. The home appliance control system of claim 15, wherein
the terminal devices are capable of changing the schedule information sent to the scheduler, and
in a case where the server determines that the first specific user among the users is not home at a timing when the operation is to finish in response to the schedule information of the first specific user among the users having been changed while the operation according to the operation schedule is being executed by the washing machine, the server regenerates an operation schedule based on the changed schedule information such that the operation of the washing machine finishes at a timing when the first specific user is at home, and sends the regenerated operation schedule to the terminal device.

26. The home appliance control system of claim 15, wherein
in a case where the server determines that only a second specific user among the users is at home based on the presence information, the server controls the washing machine such that the washing machine does not accept an operation to an operation unit of the washing machine.

27. (canceled)

28. A controller comprising:
a receiver unit configured to receive schedule information of each of a plurality of users;
a storage unit configured to store the received respective schedule information of the users; and
a control unit configured to control an operation of at least one electrical device,
wherein
each of the schedule information includes attribute information which indicates a status of corresponding one of the users, and
the control unit controls the operation of the at least one electrical device based on the attribute information common to a predetermined number or more of the users among the schedule information of the users stored in the storage unit.
